(19) United States
(12) Patent Application Publication
(10) Pub. No.: US 2025/0282194 A1
(43) Pub. Date: Sep. 11, 2025

(54) VEHICLE HAVING ADJUSTABLE COMPRESSION AND REBOUND DAMPING

(71) Applicant: Polaris Industries Inc., Medina, MN (US)

(72) Inventors: Jonathon P. Graus, Wyoming, MN (US); Adam J. LeMay, Wyoming, MN (US); Justin T. Anderson, Wyoming, MN (US); Kyle W. Olson, Wyoming, MN (US)

(21) Appl. No.: 19/064,339

(22) Filed: Feb. 26, 2025

Related U.S. Application Data
(60) Provisional application No. 63/561,627, filed on Mar. 5, 2024.
(60) Provisional application No. 63/677,480, filed on Jul. 31, 2024.

(51) Int. Cl. B60G 17/016; B62M 27/02

(52) U.S. Cl. CPC B60G 17/0164; B62M 27/02; B60G 2300/07; B60G 2400/0512; B60G 2400/106; B60G 2500/104; B62M 2027/026

(57) ABSTRACT

A damping control system for a vehicle having a suspension located between a plurality of ground engaging members and a vehicle frame are disclosed. The vehicle including at least one adjustable shock absorber having an adjustable damping characteristic.

### CROSS REFERENCE TO RELATED APPLICATIONS

The present application claims the benefit of U.S. Provisional Patent Application Ser. No. 63/561,627, filed Mar. 5, 2024, entitled “VEHICLE HAVING ADJUSTABLE COMPRESSION AND REBOUND DAMPING,” and the benefit of U.S. Provisional Patent Application Ser. No. 63/677,480, filed Jul. 31, 2024, entitled “VEHICLE HAVING ADJUSTABLE COMPRESSION AND REBOUND DAMPING,” the contents of which are expressly incorporated herein by reference.

### FIELD OF DISCLOSURE

The present disclosure relates to improved suspension characteristics for a vehicle and in particular to systems and methods of damping control, such as compression and/or rebound damping, for shock absorbers.

### BACKGROUND OF THE DISCLOSURE

Adjustable shock absorbers are known. Systems and methods for controlling one or more adjustable characteristics of adjustable shock absorbers are disclosed in US Published Patent Application No. 2016/0059660 (filed Nov. 6, 2015, titled VEHICLE HAVING SUSPENSION WITH CONTINUOUS DAMPING CONTROL) and US Published Application 2018/0141543 (filed Nov. 17, 2017, titled VEHICLE HAVING ADJUSTABLE SUSPENSION), assigned to the present assignee, the entire disclosures of which are expressly incorporated by reference herein.

### SUMMARY OF THE DISCLOSURE

In an exemplary embodiment of the present disclosure, a recreational vehicle is provided.

Some embodiments of the present disclosure provide a recreational vehicle. The recreational vehicle includes: a plurality of ground engaging members, a frame supported by the plurality of ground engaging members, a plurality of suspensions, and at least one sensor positioned on the recreational vehicle and configured to provide one or more of acceleration information, pitch information, or position information to a controller. Each of the plurality of suspensions couple a ground engaging member, from the plurality of ground engaging members, to the frame. The plurality of suspensions include a plurality of adjustable shock absorbers. The controller is operatively coupled to the at least one sensor and the plurality of adjustable shock absorbers. The controller is configured to: receive, from the at least one sensor, the one or more of acceleration information, pitch information, or position information; determine, based on the one or more of acceleration information, pitch information, or position information, to adjust damping of at least one of the plurality of adjustable shock absorbers; and provide, to the at least one of the plurality of adjustable shock absorbers, one or more commands to result in an adjustment of a damping characteristic of the at least one of the plurality of adjustable shock absorbers.

Some embodiments of the present disclosure provide a method of adjusting one or more adjustable shock absorbers of a vehicle. The method includes: receiving, from at least one sensor of the vehicle, acceleration information and pitch information; determining, based on the acceleration information and pitch information, to adjust damping of at least one of the one or more adjustable shock absorbers; and providing, to the at least one of the one or more adjustable shock absorbers, one or more commands to cause an adjustment of a damping characteristic of the at least one of the one or more adjustable shock absorbers.

Some embodiments of the present disclosure provide a recreational vehicle. The recreational vehicle includes: a plurality of ground engaging members, a frame supported by the plurality of ground engaging members, a plurality of suspensions, and at least one sensor positioned on the recreational vehicle, the at least one sensor configured to provide acceleration information and pitch information to a controller. Each of the plurality of suspensions couple a ground engaging member, from the plurality of ground engaging members, to the frame and include an adjustable shock absorber of a plurality of adjustable shock absorbers. The controller is operatively coupled to the at least one sensor and the plurality of adjustable shock absorbers. The controller is configured to: receive, from the at least one sensor, the acceleration information and the pitch information; calculate an event score based on the acceleration information and the pitch information; compare the calculated event score to a threshold; and control at least one adjustable shock absorber of the plurality of adjustable shock absorbers to adjust a damping characteristic of the at least one adjustable shock absorber based on the comparison.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The foregoing aspects and many additional features of the present system and method will become more readily appreciated and become better understood by reference to the following detailed description when taken in conjunction with the accompanying drawings, where:

FIG. 1 shows a representative view of components of a vehicle of the present disclosure having a suspension with a plurality of continuous damping control shock absorbers and a plurality of sensors integrated with a controller of the vehicle;

FIG. 2 shows an adjustable damping shock absorber coupled to a vehicle suspension;

FIG. 3 shows an x-axis, a y-axis, and a z-axis for a vehicle, such as an ATV;

FIG. 4 shows a representative view of an exemplary power system for the vehicle of FIG. 1;

FIG. 5 shows a representative view of an exemplary controller of the vehicle of FIG. 1;

FIG. 6 shows a first, perspective view of an exemplary vehicle;

FIG. 7 shows a second, perspective view of the exemplary vehicle of FIG. 6;

FIG. 8 shows a side view of the exemplary vehicle of FIG. 6;

FIG. 9 shows a bottom view of the exemplary vehicle of FIG. 6;

FIG. 10 shows an exemplary control system for controlling the damping of one or more shock absorbers;

FIG. 11 shows an example rear loading event, according to some embodiments of the present disclosure;

FIG. 12 shows an example flowchart describing the operation of a suspension controller during a rear loading event, according to some embodiments of the present disclosure;

FIG. 13 shows an example rear unloading event, according to some embodiments of the present disclosure;

FIG. 14 shows an example flowchart describing the operation of a suspension controller during a rear unloading event, according to some embodiments of the present disclosure;

FIG. 15 shows an example of the suspension controller adjusting the adjustable shock absorbers for the vehicle during rear loading/unloading events;

FIG. 16 shows an exemplary schematic block diagram illustrating an example of logic components in the suspension controller;

FIG. 17 illustrates a representative view of a stabilizer bar of the vehicle of FIG. 1; and

FIG. 18 illustrates a view of another exemplary vehicle.

### DETAILED DESCRIPTION OF EMBODIMENTS

For the purposes of promoting an understanding of the principles of the present disclosure, reference will now be made to the embodiments illustrated in the drawings, which are described below. The embodiments disclosed below are not intended to be exhaustive or limited to the precise form disclosed in the following detailed description. Rather, the embodiments are chosen and described so that others skilled in the art may utilize their teachings.

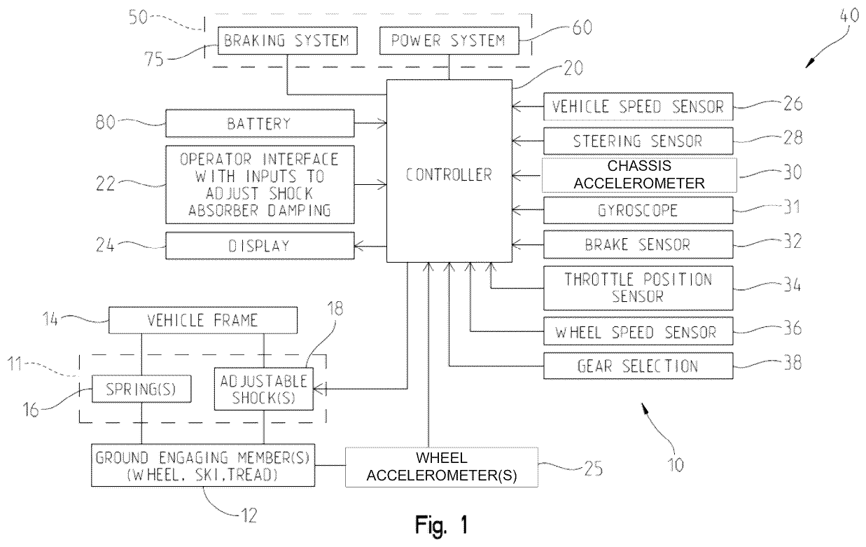

Referring now to FIG. 1, the present disclosure relates to a vehicle 10 having a suspension system 11 located between a plurality of ground engaging members 12 and a vehicle frame 14. Exemplary ground engaging members 12 include wheels, skis, guide tracks, treads or other suitable devices for supporting the vehicle relative to the ground. The suspension typically includes springs 16 and shock absorbers 18 coupled between the ground engaging members 12 and the frame 14. The springs 16 may include, for example, coil springs, leaf springs, air springs or other gas springs. The air or gas springs 16 may be adjustable. See, for example, U.S. Pat. No. 7,950,486, entitled VEHICLE (filed Jun. 6, 2008), and assigned to the current assignee, the entire disclosure of which is incorporated herein by reference.

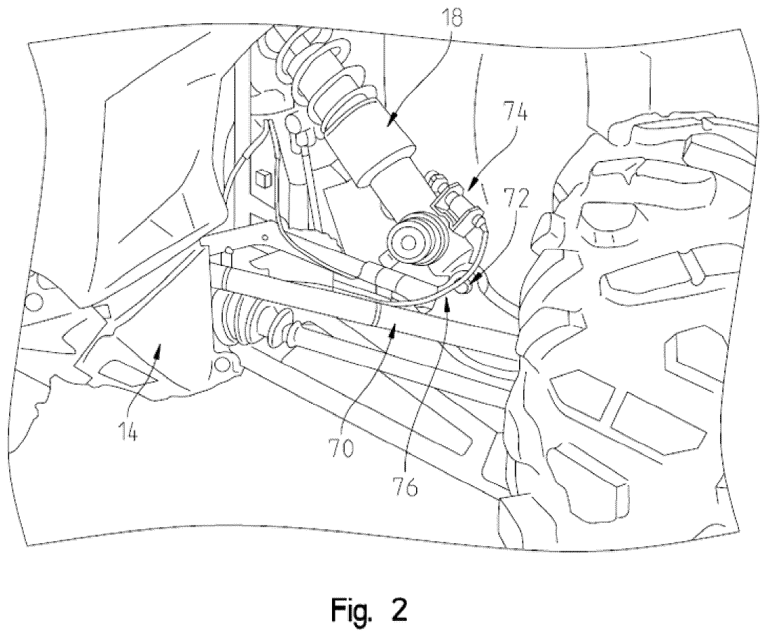

The adjustable shock absorbers 18 are often coupled between the vehicle frame 14 and the ground engaging members 12 through an A-arm linkage 70 (See FIG. 2) or other type linkage. Springs 16 are also coupled between the ground engaging members 12 and the vehicle frame 14. FIG. 2 illustrates an adjustable shock absorber 18 mounted on an A-arm linkage 70 having a first end pivotably coupled to the vehicle frame 14 and a second end pivotably coupled to A-arm linkage 70 which moves with wheel 12. A damping control activator 74 is coupled to controller 20 by one or more wires 76. An exemplary damping control activator is an electronically controlled valve which is activated to increase or decrease the damping characteristics of adjustable shock absorber 18.

In one embodiment, the adjustable shock absorbers 18 include solenoid valves mounted at the base of the shock body or internal to a damper piston of the shock absorber 18. The stiffness of the shock is increased or decreased by introducing additional fluid to the interior of the shock absorber, removing fluid from the interior of the shock absorber, and/or increasing or decreasing the ease with which fluid can pass from a first side of a damping piston of the shock absorber to a second side of the damping piston of the shock absorber. In another embodiment, the adjustable shock absorbers 18 include a magnetorheological fluid internal to the shock absorber 18. The stiffness of the shock is increased or decreased by altering a magnetic field experienced by the magnetorheological fluid. Additional details on exemplary adjustable shocks are provided in US Published Patent Application No. 2016/0059660, filed Nov. 6, 2015, entitled VEHICLE HAVING SUSPENSION WITH CONTINUOUS DAMPING CONTROL, and assigned to the present assignee, the entire disclosure of which is expressly incorporated by reference herein.

In one embodiment, a spring 16 and shock 18 are located adjacent each of the ground engaging members 12. In an all-terrain vehicle (ATV), for example, a spring 16 and an adjustable shock 18 are provided adjacent each of the four wheels 12. In a snowmobile, for example, one or more springs 16 and one or more adjustable shocks 18 are provided for each of the two front skis and the rear tread. For example, the snowmobile can have a front adjustable shock 18 for the front skis and a rear adjustable shock 18 for the rear skis. Some manufacturers offer adjustable springs 16 in the form of either air springs or hydraulic preload rings. These adjustable springs 16 allow the operator to adjust the ride height on the go. However, a majority of ride comfort comes from the damping provided by shock absorbers 18.

In an illustrated embodiment, controller 20 provides signals and/or commands to adjust damping characteristics of the adjustable shocks 18. For example, the controller 20 provides signals to adjust damping of the shocks 18 in a continuous or dynamic manner. In other words, adjustable shocks 18 may be adjusted to provide differing compression damping, rebound damping, or both. In one embodiment, adjustable shocks 18 include a first controllable valve to adjust compression damping and a second controllable valve to adjust rebound damping. In another embodiment, adjustable shocks include a combination valve which controls both compression damping and rebound damping.

In an illustrated embodiment of the present disclosure, an operator interface 22 is provided in a location easily accessible to the driver operating the vehicle. For example, the operator interface 22 is either a separate user interface mounted adjacent the driver's seat on the dashboard or integrated onto a display within the vehicle. Operator interface 22 includes user input devices to allow the driver or a passenger to manually adjust shock absorber 18 damping during operation of the vehicle based on road conditions that are encountered or to select a preprogrammed active damping profile for shock absorbers 18 by selecting a ride mode. Examples of techniques for controlling a damping characteristics of an adjustable shock absorber of a vehicle are provided in U.S. Pat. No. 10,406,884, entitled ADJUSTABLE VEHICLE SUSPENSION SYSTEM (filed Jun. 9, 2017), assigned to the present assignee, the entire disclosure of which is expressly incorporated by reference herein.

Exemplary input devices for operator interface 22 include levers, buttons, switches, soft keys, and other suitable input devices. Operator interface 22 may also include output devices to communicate information to the operator. Exemplary output devices include lights, displays, audio devices, tactile devices, and other suitable output devices. In another illustrated embodiment, the user input devices are on a steering wheel, handle bar, or other steering control of the vehicle 10 to facilitate actuation of the damping adjustment. For example, a physical switch may be located on the steering wheel, handle bar, or other steering control of the vehicle 10. In some examples, a display may be provided on or next to the operator interface 22 or integrated into a dashboard display of vehicle 10 to display information related to the compression and/or rebound damping characteristics.

As explained in further detail below, controller 20 receives kinematic measurements from one or more vehicle condition sensors 40 and adjusts the damping characteristics of the adjustable shocks 18 accordingly. The operator may independently adjust front and rear shock absorbers 18 to adjust the ride characteristics of the vehicle 10. In certain embodiments, each of the shocks 18 is independently adjustable so that the damping characteristics of the shocks 18 are changed from one side of the vehicle 10 to another. The damping response of the shock absorbers 18 can be changed in a matter of milliseconds to provide nearly instantaneous changes in damping for potholes, dips in the road, hills, or other driving conditions. Additionally, and/or alternatively, controller 20 may independently adjust the damping characteristics of front and/or rear shocks 18. An advantage, among others, of adjusting the damping characteristics of the front and/or rear shocks 18 is that the vehicle 10 may be able to operate more efficiently in rough terrain and/or improve a rider's experience.

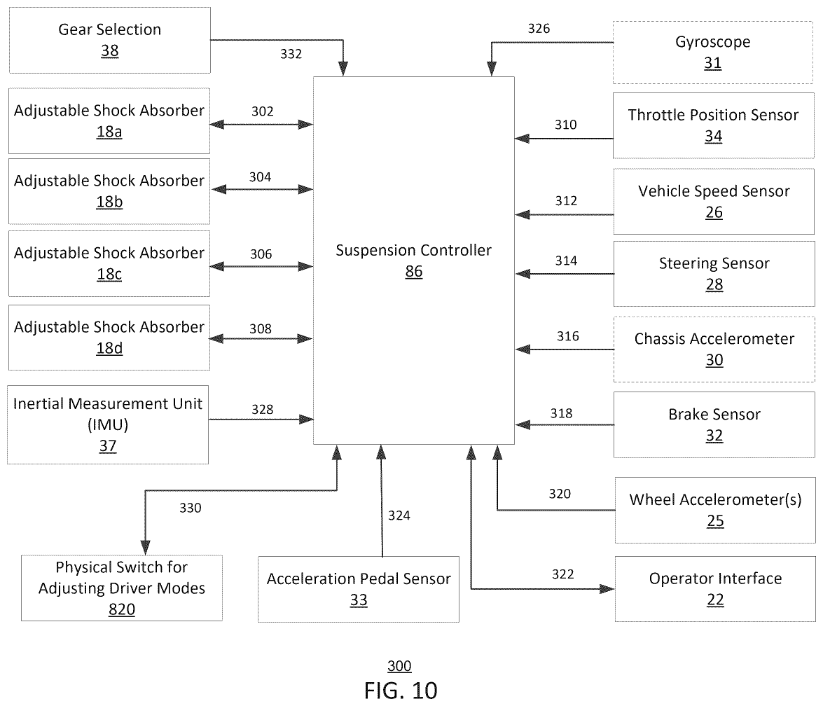

The controller 20 communicates with (e.g., provides, transmits, receives, and/or obtains) multiple vehicle condition sensors 40. For example, a wheel accelerometer 25 is coupled adjacent each ground engaging member 12. The controller 20 communicates with each of the accelerometers 25. For instance, the accelerometers 25 may provide information indicating movement of the ground engaging members and the suspension components 16 and 18 as the vehicle traverses different terrain. Further, the controller 20 may communicate with additional vehicle condition sensors 40, such as a vehicle speed sensor 26, a steering sensor 28, a chassis supported accelerometer 30, a chassis supported gyroscope 31, an inertial measurement unit (IMU) 37 (shown on FIG. 10), a physical switch 820 (shown on FIG. 10), and other sensors which monitor one or more characteristics of vehicle 10.

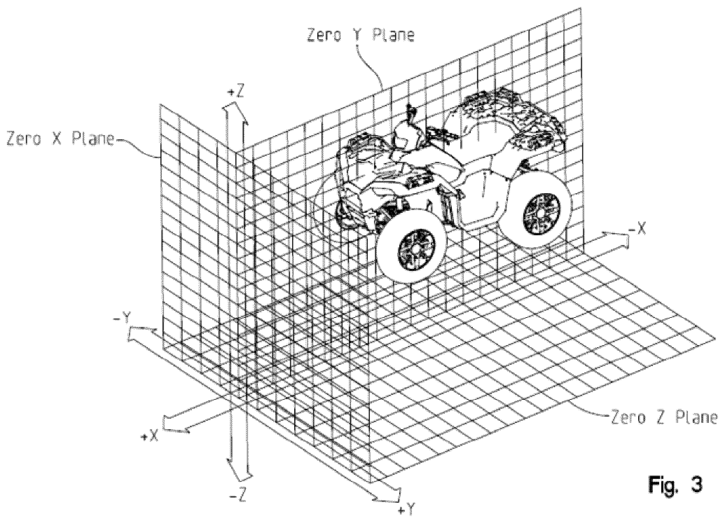

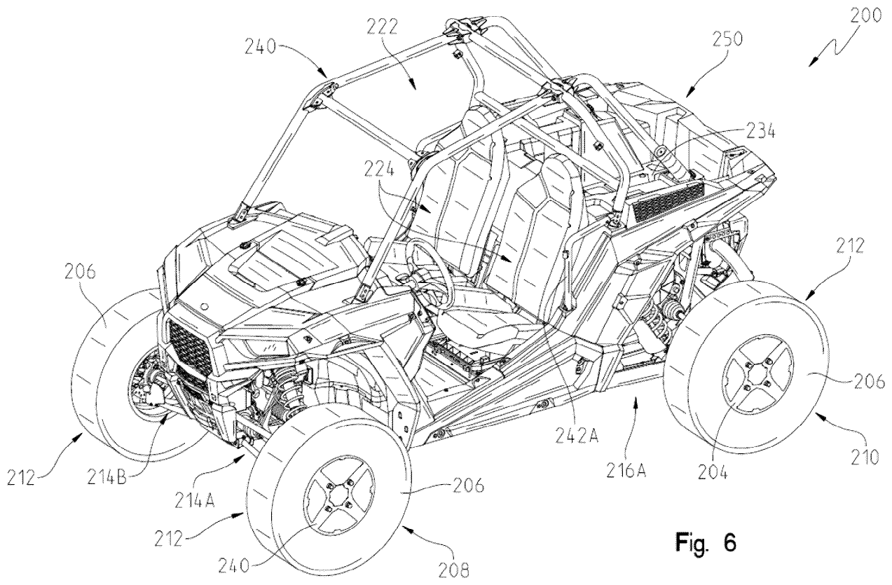

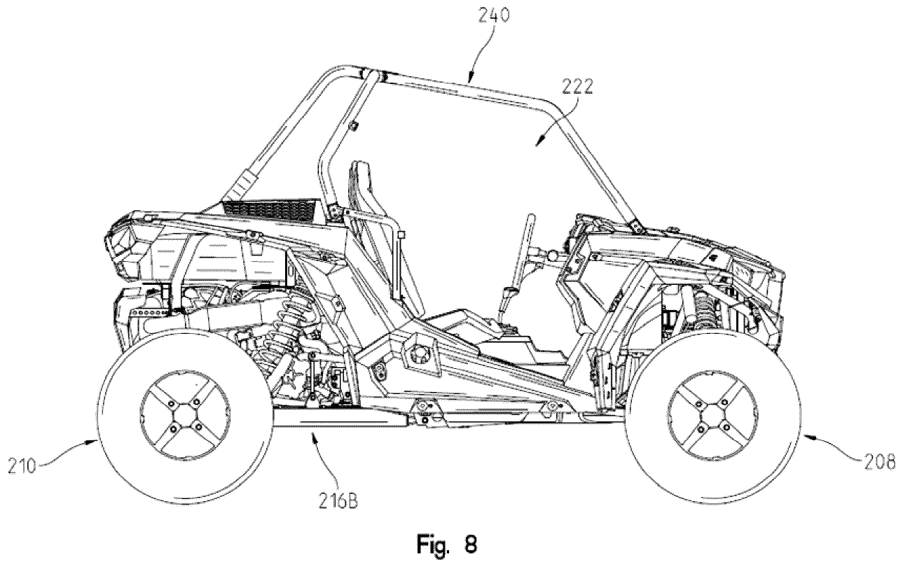

Accelerometer 30 is illustratively a three-axis accelerometer supported on the chassis of the vehicle 10 to provide information indicating acceleration forces of the vehicle 10 during operation. In some instances, accelerometer 30 is located at or close to a center position (e.g., a center of gravity position) of vehicle 10. In other instances, the accelerometer 30 is located at a position that is not near the center of gravity of the vehicle 10. In the exemplary vehicle 200 illustrated in FIGS. 6-9, the chassis accelerometer 30 is located along a longitudinal centerline plane 122 of vehicle 200. The x-axis, y-axis, and z-axis for a vehicle 10, illustratively an ATV, are shown in FIG. 3.

Gyroscope 31 is illustratively a three-axis gyroscope supported on the chassis to provide indications of inertial measurements, such as roll rates, pitch rates, and/or yaw rates, of the vehicle during operation. In one embodiment, accelerometer 30 is not located at a center of gravity of vehicle 10 and the readings of gyroscope 31 are used by controller 20 to determine the acceleration values of vehicle 10 at the center of gravity of vehicle 10. In one embodiment, accelerometer 30 and gyroscope 31 are integrated into the controller 20, such as a suspension controller 86.

In some examples and referring to FIG. 10, an IMU, such as the IMU 37 is supported on the chassis to provide indications of the inertial measurements, including the angular rate and/or the acceleration forces, of the vehicle 10 during operation. The IMU 37 may include the functionalities of the accelerometer 30 and/or the gyroscope 31. As such, in some instances, the accelerometer 30 and/or the gyroscope 31 are optional and might not be included in the vehicle 10. In other instances, the vehicle 10 may include the gyroscope 31 and the accelerometer 30 instead of the IMU 37.

The controller 20 may also communicate with additional vehicle condition sensors 40, such as a brake sensor 32, a throttle position sensor 34, a wheel speed sensor 36, and/or a gear selection sensor 38.

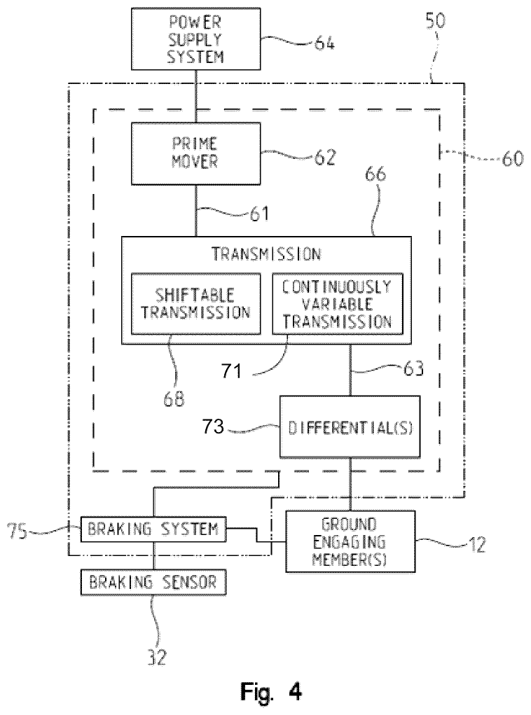

Referring to FIG. 4, one embodiment of a driveline torque management system 50 of vehicle 10 is illustrated. Driveline torque management system 50 controls the amount of torque exerted by each of ground engaging members 12. Driveline torque management system 50 provides a positive torque to one or more of ground engaging members 12 to power the movement of vehicle 10 through a power system 60. Driveline torque management system 50 further provides a negative torque to one or more of ground engaging members 12 to slow or stop a movement of vehicle 10 through a braking system 75. In one example, each of ground engaging members 12 has an associated brake of braking system 75.

Power system 60 includes a prime mover 62. Exemplary prime movers 62 include internal combustion engines, two stroke internal combustion engines, four stroke internal combustion engines, diesel engines, electric motors, hybrid engines, and other suitable sources of motive force. To start the prime mover 62, a power supply system 64 is provided. The type of power supply system 64 depends on the type of prime mover 62 used. In one embodiment, prime mover 62 is an internal combustion engine and power supply system 64 is one of a pull start system and an electric start system. In one embodiment, prime mover 62 is an electric motor and power supply system 64 is a switch system which electrically couples one or more batteries to the electric motor.

A transmission 66 is coupled to prime mover 62. Transmission 66 converts a rotational speed of an output shaft 61 of prime mover 62 to one of a faster rotational speed or a slower rotational speed of an output shaft 63 of transmission 66. It is contemplated that transmission 66 may additionally rotate output shaft 63 at the same speed as output shaft 61.

In the illustrated embodiment, transmission 66 includes a shiftable transmission 68 and a continuously variable transmission (“CVT”) 71. In one example, an input member of CVT 71 is coupled to prime mover 62. An input member of shiftable transmission 68 is in turn coupled to an output member of CVT 71. In one embodiment, shiftable transmission 68 includes a forward high setting, a forward low setting, a neutral setting, a park setting, and a reverse setting. The power communicated from prime mover 62 to CVT 71 is provided to a drive member of CVT 71. The drive member in turn provides power to a driven member through a belt. Exemplary CVTs are disclosed in U.S. Pat. Nos. 3,861,229; 6,176,796; 6,120,399; 6,860,826; and 6,938,508, the disclosures of which are expressly incorporated by reference herein. The driven member provides power to an input shaft of shiftable transmission 68. Although transmission 66 is illustrated as including both shiftable transmission 68 and CVT 71, transmission 66 may include only one of shiftable transmission 68 and CVT 71. Further, transmission 66 may include one or more additional components.

Transmission 66 is further coupled to at least one differential 73 which is in turn coupled to at least one ground engaging members 12. Differential 73 may communicate the power from transmission 66 to one of ground engaging members 12 or multiple ground engaging members 12. In an ATV embodiment, one or both of a front differential and a rear differential are provided. The front differential powering at least one of two front wheels of the ATV and the rear differential powering at least one of two rear wheels of the ATV. In a side-by-side vehicle embodiment having seating for at least an operator and a passenger in a side-by-side configuration, one or both of a front differential and a rear differential are provided. The front differential powering at least one of two front wheels of the side-by-side vehicle and the rear differential powering at least one of multiple rear wheels of the side-by-side vehicle. In one example, the side-by-side vehicle has three axles and a differential is provided for each axle. An exemplary side-by-side vehicle 200 is illustrated in FIGS. 6-9.

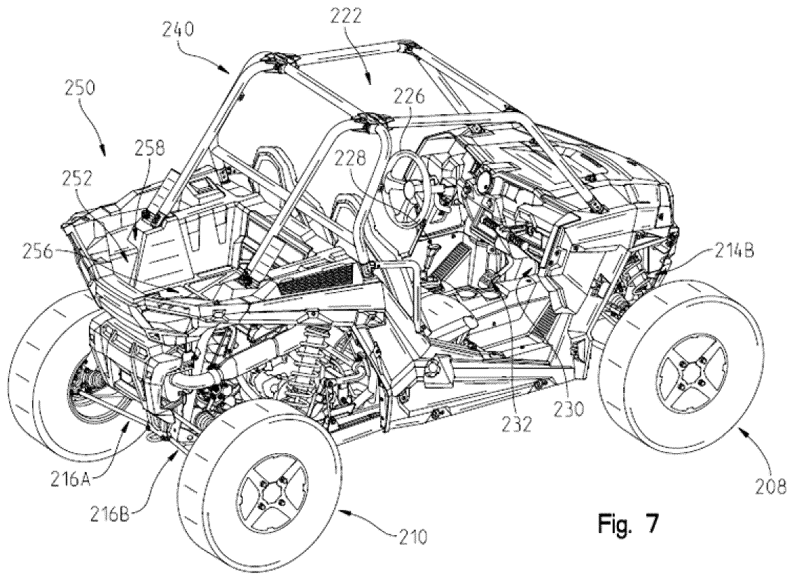

In one embodiment, braking system 75 includes anti-lock brakes. In one embodiment, braking system 75 includes active descent control and/or engine braking. In one embodiment, braking system 75 includes a brake and in some embodiments a separate parking brake. Braking system 75 may be coupled to any of prime mover 62, transmission 66, differential 73, and ground engaging members 12 or the connecting drive members therebetween. Brake sensor 32, in one example, monitors when braking system 75 is applied. In one example, brake sensor 32 monitors when a user actuatable brake input, such as brake pedal 232 (see FIG. 7) in vehicle 200, is applied.

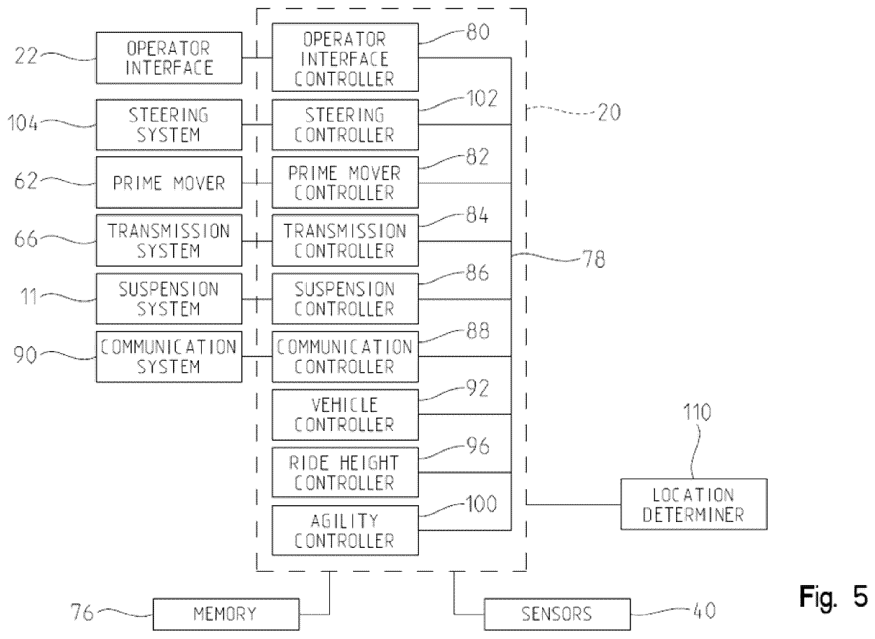

Referring to FIG. 5, controller 20 has at least one associated memory 76. Controller 20 provides the electronic control of the various components of vehicle 10. Further, controller 20 is operatively coupled to a plurality of vehicle condition sensors 40 as described above, which monitor various parameters of the vehicle 10 or the environment surrounding the vehicle 10. Controller 20 performs certain operations (e.g., provides commands) to control one or more subsystems of other vehicle components. In certain embodiments, the controller 20 forms a portion of a processing subsystem including one or more computing devices having memory, processing, and communication hardware. Controller 20 may be a single device or a distributed device, and the functions of the controller 20 may be performed by hardware and/or as computer instructions on a non-transitory computer readable storage medium, such as memory 76.

As illustrated in the embodiment of FIG. 5, controller 20 is represented as including several controllers. These controllers may each be single devices or distributed devices or one or more of these controllers may together be part of a single device or distributed device. The functions of these controllers may be performed by hardware and/or as computer instructions on a non-transitory computer readable storage medium, such as memory 76.

In one embodiment, controller 20 includes at least two separate controllers which communicate over a network 78. In one embodiment, network 78 is a CAN network. Details regarding an exemplary CAN network are disclosed in U.S. patent application Ser. No. 11/218,163, filed Sep. 1, 2005, the disclosure of which is expressly incorporated by reference herein. Of course any suitable type of network or data bus may be used in place of the CAN network. In one embodiment, two wire serial communication is used for some connections.

Referring to FIG. 5, controller 20 includes an operator interface controller 80 which controls communication with an operator through operator interface 22. A prime mover controller 82 controls the operation of prime mover 62. A transmission controller 84 controls the operation of transmission system 66.

A suspension controller 86 controls adjustable portions of suspension system 11. Exemplary adjustable components include adjustable shocks 18, adjustable springs 16, and/or configurable stabilizer bars. Additional details regarding adjustable shocks, adjustable springs, and configurable stabilizer bars is provided in US Published Patent Application No. 2016/0059660, filed Nov. 6, 2015, entitled VEHICLE HAVING SUSPENSION WITH CONTINUOUS DAMPING CONTROL, and assigned to the present assignee, the entire disclosure of which is expressly incorporated by reference herein.

Communication controller 88 controls communications between a communication system 90 of vehicle 10 and remote devices, such as other vehicles, personal computing devices, such as cellphones or tablets, a centralized computer system maintaining one or more databases, and other types of devices remote from vehicle 10 or carried by riders of vehicle 10. In one embodiment, communication controller 88 of vehicle 10 communicates with paired devices over a wireless network. An exemplary wireless network is a radio frequency network utilizing a BLUETOOTH protocol. In this example, communication system 90 includes a radio frequency antenna. Communication controller 88 controls the pairing of devices to vehicle 10 and the communications between vehicle 10 and the remote device. In one embodiment, communication controller 88 of vehicle 10 communicates with remote devices over a cellular network. In this example, communication system 90 includes a cellular antenna and communication controller 88 receives and sends cellular messages from and to the cellular network. In one embodiment, communication controller 88 of vehicle 10 communicates with remote devices over a satellite network. In this example, communication system 90 includes a satellite antenna and communication controller 88 receives and sends messages from and to the satellite network. In one embodiment, vehicle 10 is able to communicate with other vehicles 10 over a Radio Frequency mesh network and communication controller 88 and communication system 90 are configured to enable communication over the mesh network. An exemplary vehicle communication system is disclosed in U.S. patent application Ser. No. 15/262,113, filed Sep. 12, 2016, entitled VEHICLE TO VEHICLE COMMUNICATIONS DEVICE AND METHODS FOR RECREATIONAL VEHICLES, and assigned to the present assignee, the entire disclosure of which is expressly incorporated by reference herein.

A steering controller 102 controls portions of a steering system 104. In one embodiment, steering system 104 is a power steering system and includes one or more steering sensors 28 (shown in FIG. 1). Exemplary sensors and electronic power steering units are provided in U.S. patent application Ser. No. 12/135,107, assigned to the assignee of the present application, titled VEHICLE, docket PLR-06-22542.02P, the disclosure of which is expressly incorporated by reference herein. A vehicle controller 92 controls lights, loads, accessories, chassis level functions, and other vehicle functions. A ride height controller 96 controls the preload and operational height of the vehicle. In one embodiment, ride height controller controls springs 16 to adjust a ride height of vehicle 10, either directly or through suspension controller 86. In one example, ride height controller 96 provides more ground clearance in a comfort ride mode compared to a sport ride mode.

An agility controller 100 controls a braking system of vehicle 10 and the stability of vehicle 10. Control methods of agility controller 100 may include integration into braking circuits (ABS) such that a stability control system can improve dynamic response (vehicle handling and stability) by modifying the shock damping in conjunction with electronic braking control.

In one embodiment, controller 20 either includes a location determiner 110 and/or communicates via network 78 to a location determiner 110. The location determiner 110 determines a current geographical location of vehicle 10. An exemplary location determiner 110 is a GPS unit which determines the position of vehicle 10 based on interaction with a global satellite system.

Referring to FIGS. 6-9, an exemplary side-by-side vehicle 200 is illustrated. Vehicle 200, as illustrated, includes a plurality of ground engaging members 12. Illustratively, ground engaging members 12 are wheels 204 and associated tires 206. As mentioned herein, one or more of ground engaging members 12 are operatively coupled to power system 60 (see FIG. 4) to power the movement of vehicle 200 and braking system 75 to slow movement of vehicle 200.

Referring to the illustrated embodiment in FIG. 6, a first set of wheels, one on each side of vehicle 200, generally correspond to a front axle 208. A second set of wheels, one on each side of vehicle 200, generally correspond to a rear axle 210. Although each of front axle 208 and rear axle 210 are shown having a single ground engaging member 12 on each side, multiple ground engaging members 12 may be included on each side of the respective front axle 208 and rear axle 210. As configured in FIG. 6, vehicle 200 is a four wheel, two axle vehicle.

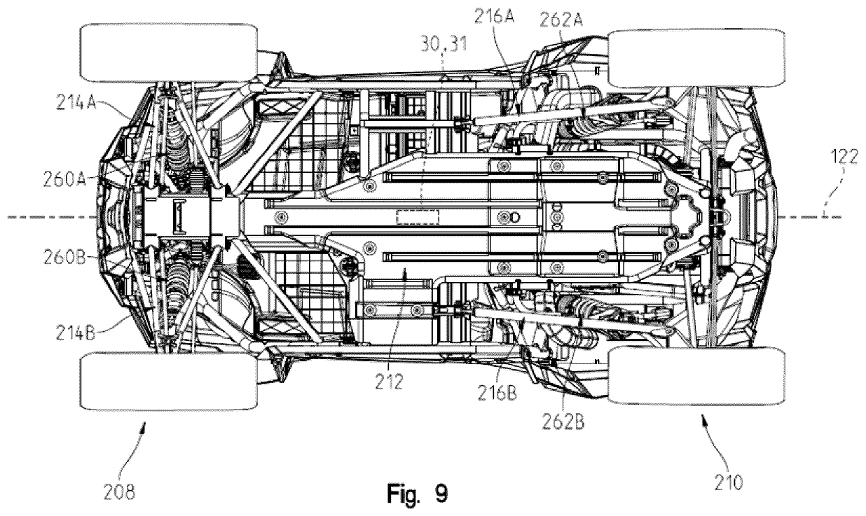

Referring to FIG. 9, wheels 204 of front axle 208 are coupled to a frame 212 of vehicle 200 through front independent suspensions 214. Front independent suspensions 214 in the illustrated embodiment are double A-arm suspensions. Other types of suspensions systems may be used for front independent suspensions 214. The wheels 204 of rear axle 210 are coupled to frame 212 of vehicle 200 through rear independent suspensions 216. Other types of suspensions systems may be used for rear independent suspensions 216.

Returning to FIG. 6, vehicle 200 includes a cargo carrying portion 250. Cargo carrying portion 250 is positioned rearward of an operator area 222. Operator area 222 includes seating 224 and a plurality of operator controls. In the illustrated embodiment, seating 224 includes a pair of bucket seats. In one embodiment, seating 224 is a bench seat. In one embodiment, seating 224 includes multiple rows of seats, either bucket seats or bench seats or a combination thereof. Exemplary operator controls include a steering wheel 226, a gear selector 228, an accelerator pedal 230 (see FIG. 7), and a brake pedal 232 (see FIG. 7). Steering wheel 226 is operatively coupled to the wheels of front axle 208 to control the orientation of the wheels relative to frame 212. Gear selector 228 is operatively coupled to the shiftable transmission 68 to select a gear of the shiftable transmission 68. Exemplary gears include one or more forward gears, one or more reverse gears, and a park setting. Accelerator pedal 230 is operatively coupled to prime mover 62 to control the speed of vehicle 200. Brake pedal 232 is operatively coupled to brake units associated with one or more of wheels 204 to slow the speed of vehicle 200.

Operator area 222 is protected with a cage 240. Referring to FIG. 6, side protection members 242 are provided on both the operator side of vehicle 200 and the passenger side of vehicle 200. In the illustrated embodiment, side protection members 262 are each a unitary tubular member.

In the illustrated embodiment, cargo carrying portion 250 includes a cargo bed 234 having a floor 256 and a plurality of upstanding walls. Floor 256 may be flat, contoured, and/or comprised of several sections. Portions of cargo carrying portion 250 also include mounts 258 which receive an expansion retainer (not shown). The expansion retainers which may couple various accessories to cargo carrying portion 250. Additional details of such mounts and expansion retainers are provided in U.S. Pat. No. 7,055,454, to Whiting et al., filed Jul. 13, 2004, titled “Vehicle Expansion Retainers,” the entire disclosure of which is expressly incorporated by reference herein.

Front suspensions 214A and 214B each include a shock absorber 260, respectively. Similarly, rear suspensions 216A and 216B each include a shock absorber 262. In one embodiment each of shock absorbers 260 and shock absorbers 262 are electronically adjustable shocks 18 which are controlled by a controller 20 of vehicle 200.

Additional details regarding vehicle 200 are provided in U.S. Pat. Nos. 8,827,019 and 9,211,924, assigned to the present assignee, the entire disclosures of which are expressly incorporated by reference herein. Other exemplary recreational vehicles include ATVs, utility vehicles, snowmobiles, other recreational vehicles designed for off-road use, on-road motorcycles, and other suitable vehicles (e.g., FIG. 31).

FIG. 10 shows an exemplary control system 300 for controlling the damping of shock absorbers 18. In some instances, the control system 300 may be included in the vehicle 10 and/or the vehicle 200 described above. For example, the suspension controller 86 may communicate with (e.g., receive and/or provide) one or more entities (e.g., sensors, devices, controllers, and/or subsystems) from the vehicle 10 and/or 200 described above. Additionally, and/or alternatively, the vehicle 10 and 200 may be the same vehicle (e.g., the vehicle 200 may include entities from vehicle 10, such as the suspension controller 86).

Additionally, the controller 20 may include a suspension controller 86 as described above in FIG. 5. The suspension controller 86 may communicate with the plurality of vehicle condition sensors 40 as described above. Further, the suspension controller 86 may provide information (e.g., one or more commands) to each of the adjustable shock absorbers 18a, 18b, 18c, and 18d. For example, the suspension controller 86 may provide commands to adjust the compression damping characteristic and/or the rebound damping characteristic for the adjustable shock absorbers 18a, 18b, 18c, and 18d.

While exemplary sensors, devices, controllers, and/or subsystems are provided in FIG. 10, additional exemplary sensors, devices, controllers, and/or subsystems used by the suspension controller 86 to adjust shock absorbers 18 are provided in US Published Patent Application No. 2016/0059660 (filed Nov. 6, 2015), entitled VEHICLE HAVING SUSPENSION WITH CONTINUOUS DAMPING CONTROL, and US Published Application 2018/0141543 (filed Nov. 17, 2017), titled VEHICLE HAVING ADJUSTABLE SUSPENSION, both assigned to the present assignee and the entire disclosures of each expressly incorporated by reference herein.

The illustrative control system 300 is not intended to suggest any limitation as to the scope of use or functionality of embodiments of the present disclosure. Neither should the illustrative control system 300 be interpreted as having any dependency or requirement related to any single entity or combination of entities illustrated therein. Additionally, various entities depicted in FIG. 10, in embodiments, may be integrated with various ones of the other entities depicted therein (and/or entities not illustrated). For example, the suspension controller 86 may be included within the controller 20, and may communicate with one or more vehicle condition sensors 40 as described above. The functionalities of the suspension controller 86 and/or other entities in control system 300 will be described below.

In some examples, the control system 300 can be used to control the damping of shock absorbers 18, such as to reduce the effects of a rear loading event and/or a rear unloading event. In some examples, the control system 300 may be used to control the damping of shock absorbers 18, such as to reduce the effect and an inclined and/or declined terrain traversed by the vehicle. In some examples, the rear loading event may be called a “G-Out” event in which the vehicle experiences rearward pitch motion while under high vertical G-loading. In some examples, the rear unloading event may be called a “Donkey Kick” event in which the vehicle experiences forward pitch motion while the vehicle is unloading from high vertical G-loading. In some examples, the control system 300 may be used to reduce the effects of a rear loading event to prevent a vehicle (e.g., vehicle 10 and/or vehicle 200) from bottoming out of rear shocks. In some examples, the vehicle might experience a rear loading event where rear shocks of the vehicle bottom out because the vehicle is driven into an incline (e.g., a hill). For example, when the front of the vehicle traverses the incline it creates high vertical G-loading and then when the rear traverses the incline the rear shocks can bottom out due to the high vertical G-loading and rearward pitch motion. In some examples, vertical G-loading is a measure of the force experienced by the vehicle due to acceleration in the vertical direction, where 1G is equivalent to the force of gravity on Earth's surface.

In some examples, a rear loading event and a rear unloading event are related because the initial bottoming out of a vehicle onto the face of an incline and using the travel of the vehicle's suspension system (e.g., a spring/jounce bumper) can contribute to causing the rear end of the vehicle to kick upward into the air and/or forward, such as in a rear unloading event. For example, the bottoming out of a vehicle can refer to one or more adjustable shock absorbers (e.g., shock absorbers 18) of a suspension system (e.g., the suspension system 11) reaching the limits (or relatively near to the limits) of its travel or compression. In some examples, the bottoming out can be caused due to a sudden increase in load or a significant bump or dip in a surface along which the vehicle is travelling. The bottoming out can cause the vehicle to sustain a sudden jolt or impact, potentially putting strain on the suspension components. Further, in some examples, the sudden jolt (e.g., an increase in vertical acceleration) or impact can cause significant energy to be stored in the springs of the suspension system (e.g., coil over spring, jounce bumper, tire), which can then result in a rear unloading event, such as when the energy is subsequently released. However, the rebound damping described herein can slow the release of this stored energy therefore reducing and/or eliminating the rear unloading event. During a rear loading event, systems described herein can reduce the energy stored in the springs of the suspension system by controlling compressing damping during the rear loading event.

### Rear Loading Event (G-Out Event)

In some examples, the control system 300 enables a fast-acting functionality that momentarily stiffens up shock absorbers on a vehicle (e.g., rear shock absorbers), such as in situations where the vehicle is in a rear loading event, loading a vehicle's suspension into the face of a jump under compression, or generally if there is a relatively large amount of pitch motion. This functionality may thus result in a vehicle with an improved rider experience because the vehicle can have improved performance on relatively rough terrain.

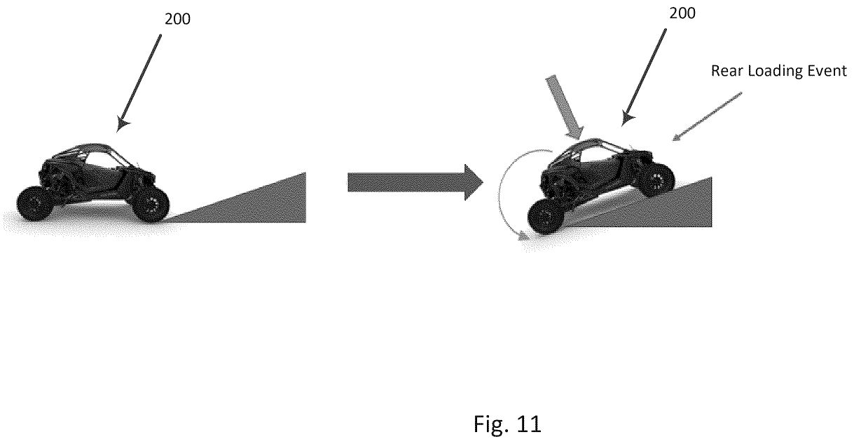

FIG. 11 illustrates an example of a rear loading event, such as for vehicle 200 or vehicle 10. In some examples, to reduce the effects of a rear loading event (e.g., where a rear of the vehicle may bottom out), the control system 300 may detect a change in vertical acceleration and change in pitch rate indicating that the vehicle is transitioning onto the face of an incline (e.g., a hill or other graded terrain) and/or landing a jump on the front axle of a vehicle with the rear axle then rapidly moving down. In examples, the control system 300 is configured to detect higher than normal G-loading and a rearward pitch rate (e.g., an increased vertical force or acceleration on the rear axle of a vehicle). In some examples, the change in vertical acceleration may be an increase or a decrease (e.g., depending on the point of reference). In some examples, the change in pitch rate may be an increase or a decrease (e.g., depending on the point of reference). In some examples, the control system 300 may detect a change in position of one or more components of the vehicle 200. For example, the control system 300 may detect a change in position of one or more adjustable shock absorbers of the vehicle 200. Other examples of vehicle components of which the control system 300 may monitor positioning to determine whether a rear loading event is occurring should be recognized by those of ordinary skill in the art.

In some examples, after detecting the changes in one or more of vertical acceleration, pitch rate, or vehicle component positioning, the control system 300 may then transmit a signal to enable an adjustment of a damping characteristic of one or more adjustable shock absorbers of the vehicle. In some examples, transmitting the signal may result in or cause the adjustment of the damping characteristic. In some examples, the adjustment of a damping characteristic (e.g., change in compression damping of one or more rear adjustable shock absorbers) may be implemented over a period of time (e.g., such that the change in rear compression is not implemented all at once). In some examples, the change in rear compression may be implemented all at once. In some examples, by changing (e.g., adding) rear compression to the vehicle, the control system 300 may prevent the rear from bottoming out (or, as another example, reduce the extent to which the rear uses compression travel) due to the terrain into which the vehicle is being driven and pitch motion of the vehicle. In some examples, adding the rear compression can enable improved control of vehicle pitch motion, thus helping to control the vehicle more easily. In some examples, the improved vehicle control may be particularly beneficial in whoops terrain (e.g., off-roading terrain with sudden drops, unexpected obstacles, and/or uneven surfaces) and/or in situations where an operator of the vehicle gets the vehicle pitching forward and back.

In some examples, the change in vertical acceleration, vehicle component positioning, and/or change in pitch rate are compared to one or more thresholds to determine whether to implement an adjustment of a damping characteristic to one or more adjustable shock absorbers of the vehicle. Therefore, by comparing the changes to such thresholds, mechanisms provided herein may ensure that adjustments to damping characteristics of adjustable shock absorbers are not made during relatively normal driving conditions, but rather only during rear loading events. In some examples, the vertical acceleration is multiplied by the pitch rate to determine a rear loading event score and/or magnitude. In some examples, the rear loading event score is compared to a threshold to determine whether to implement an adjustment of a damping characteristic to one or more adjustable shock absorbers of the vehicle. Additional and/or alternative calculations, which use and/or are based on the changes in acceleration, vehicle component positioning, and/or pitch rate, to calculate the rear loading event score, should be recognized by those of ordinary skill in the art.

In some examples, the rear loading event score, change in acceleration, change in vehicle component positioning, and/or change in pitch rate may be compared to a look-up table to determine whether to adjust a damping characteristic of one or more adjustable shock absorbers of the vehicle. In some examples, the comparison to the look-up table may be used to determine what type of damping characteristic (e.g., compression damping and/or rebound damping) to adjust. In some examples, the comparison to the look-up table may be used to determine how much to adjust the damping characteristic of the one or more adjustable shock absorbers of the vehicle.

In some examples, the thresholds to which the changes in vertical acceleration, vehicle component positioning, and/or pitch rate are compared may be calibrated. For example, the thresholds may be calibrated based on and/or correspond to a type of vehicle (e.g., vehicle model), mode of vehicle (e.g., ECO mode, sport mode, work mode, two-wheel drive, four-wheel drive, etc.), operator preference, manufacture preference, historical data of vehicle component positioning, acceleration, and/or pitch information (e.g., vertical acceleration and pitch rate) collected over a duration of time (e.g., hours, days, months years), or other factors which should be recognized by those of ordinary skill in the art. Similarly, in some examples, the look-up table may be calibrated. For example, the look-up table may be calibrated based on and/or correspond to a type of vehicle (e.g., vehicle model), mode of vehicle (e.g., ECO mode, sport mode, work mode, two-wheel drive, four-wheel drive, etc.), operator preference, manufacture preference, historical data of vehicle component positioning, acceleration, and/or pitch information (e.g., vertical acceleration and pitch rate) collected over a duration of time (e.g., hours, days, months years), or other factors which should be recognized by those of ordinary skill in the art.

In some examples, the control system 300 functions continuously, such that adjustments to damping characteristics of one or more shock absorbers of the vehicle are made smoothly, rather than as a binary on/off function. In some examples, the vertical acceleration and/or change in pitch rate are received from an IMU, such as the IMU 37 of FIG. 10. In some examples, the vehicle component positioning measurements are received from a shock absorber position sensor (e.g., such as when measuring the position of shock absorbers). In some examples, the control system 300 may be in communication with other types of sensors, such as wheel acceleration sensors, shock acceleration sensors, axle sensors, camera sensors, radar sensors, or any other sensors recognized by those of ordinary skill in the art which may be used to detect when vehicle suspension is going to compress or unload. Accordingly, in some examples, the control system 300 can transmit one or more signals to enable adjustments to one or more adjustable shock absorbers, in addition to or independent of kinematic sensors of a vehicle. Examples of cameras/radars which may be used in accordance with aspects of the present disclosure are provided in U.S. patent application Ser. No. 18/592,643, entitled VEHICLE (filed Mar. 1, 2024), which is incorporated by reference herein in its entirety. Further, in some examples, terrain detection can be implemented, such as using terrain detection techniques described in PCT/US2024/012271, entitled TERRAIN DETECTION AND METHODS OF USE THEREOF (filed Jan. 19, 2024), which is incorporated by reference herein in its entirety. For example, one of ordinary skill in the art will recognize in view of PCT/US2024/012271 how a LIDAR sensor or other type of vision sensor can be used to provide input to the control system 300 for adjusting characteristics of the shock absorbers of the vehicle.

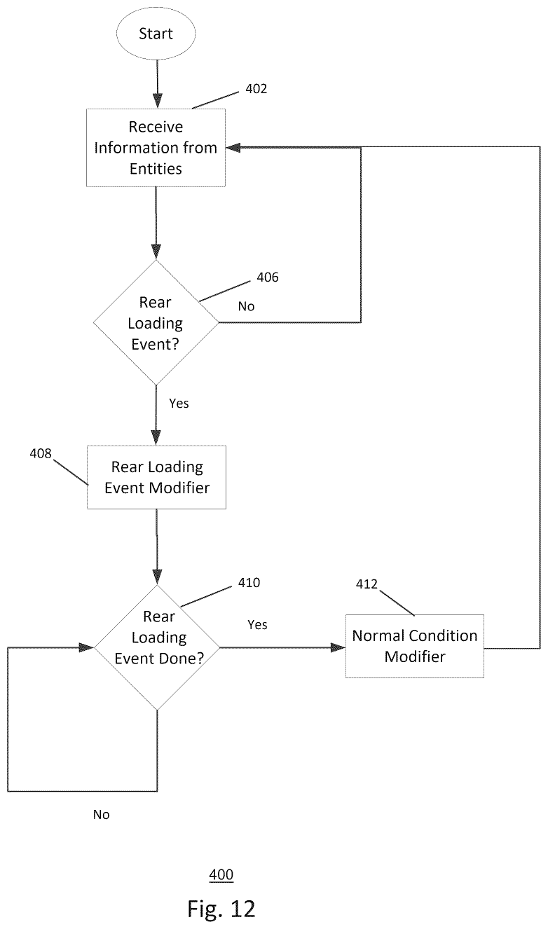

FIG. 12 shows an example flowchart describing the operation of the suspension controller 86 during a rear loading event. The flowchart illustrates an example method or process 400. In some examples, the method 400 is a method of adjusting one or more adjustable shock absorbers. As will be described in more detail below, by adjusting the compression damping of one or more adjustable shock absorbers 18 due to a rear loading event, the suspension controller 86 may increase the efficiency of vehicle 10 by preventing the vehicle 10 from bottoming out.

In operation, at step 402, the suspension controller 86 may receive information (e.g., inputs) from one or more entities (e.g., sensors, devices, and/or subsystems) of vehicle 10. For example, the suspension controller 86 may receive (e.g., retrieve and/or obtain) information (e.g., data packets and/or signals indicating sensor readings) from the one or more sensors, devices, and/or subsystems. In some instances, the suspension controller 86 may receive information indicating the x, y, and/or z-axis acceleration from the chassis accelerometer 30 and/or IMU 37. For example, referring back to FIG. 3, the chassis accelerometer 30 and/or IMU 37 may measure the x, y, and/or z-axis acceleration values for the vehicle 10, and may provide the acceleration values to the suspension controller 86. Further, the suspension controller 86 may receive information indicating a pitch rate of the vehicle, such as from the IMU 37. Still further, the suspension controller 86 may receive information indicating a position of a component of the vehicle, such as from a shock absorber positioning sensor and/or a positioning sensor configured to monitor the position of another vehicle component.

At step 406, the suspension controller 86 may determine whether a rear loading event is occurring. For example, the suspension controller 86 may determine whether a rear loading event is occurring based on the z-axis acceleration value (i.e., vertical acceleration) and pitch rate of the vehicle. For instance, the suspension controller 86 may compare the z-axis acceleration and pitch rate values with one or more thresholds (e.g., one or more pre-defined, pre-programmed, and/or user-defined thresholds) to determine whether the vehicle 10 is in a rear loading event. If the z-axis acceleration value and pitch rate value are greater than the one or more thresholds, the method 400 may move to step 408. If the z-axis acceleration value and pitch rate value are less than the thresholds, the method 400 may move back to step 402 and repeat.

In some examples, the suspension controller 86 may use any of a plurality of different techniques for comparing the z-axis acceleration and pitch rate to thresholds. In some examples, the z-axis acceleration is multiplied by the pitch rate to determine a rear loading event score and/or magnitude. In some examples, the rear loading event score is compared to a threshold to determine whether to implement an adjustment of a damping characteristic to one or more adjustable shock absorbers of the vehicle. Additional and/or alternative calculations, which use and/or are based on the changes in acceleration and pitch rate, to calculate the rear loading event score, should be recognized by those of ordinary skill in the art.

In some examples, the rear loading event score, change in acceleration, and/or change in pitch rate may be compared to a look-up table to determine whether to adjust a damping characteristic of one or more adjustable shock absorbers of the vehicle. In some examples, the comparison to the look-up table may be used to determine what type of damping characteristic (e.g., compression damping and/or rebound damping) to adjust. In some examples, the comparison to the look-up table may be used to determine how much to adjust the damping characteristic of the one or more adjustable shock absorbers of the vehicle.

At step 408, the suspension controller 86 may determine a rear loading event modifier for one or more of the adjustable shock absorbers 18. For example, the suspension controller 86 may provide information (e.g., one or more commands) to the adjustable shock absorbers 18 to increase and/or gradually increase the compression damping. By increasing the compression damping of the adjustable shock absorbers 18, the vehicle 10 may increase the energy absorption capability of the shock absorbers to thus prevent or reduce the extent to which the rear of the vehicle bottoms out and/or an amount of suspension travel used.

At step 410, the suspension controller 86 may determine whether a rear loading event has occurred and/or is done/completed. For example, similar to step 406, the suspension controller 86 may determine whether the rear loading event is done based on the z-axis acceleration value and/or pitch rate of the vehicle. For instance, the suspension controller 86 may compare the z-axis acceleration value and/or pitch rate with one or more thresholds (e.g., one or more pre-defined, pre-programmed, and/or user-defined thresholds) to determine whether the vehicle 10 is no longer in a rear loading event. In some examples, the suspension controller 86 may use the same thresholds as in step 406.

At step 412, the suspension controller 86 may execute a normal condition modifier. For example, the suspension controller 86 may adjust the compression damping back to normal (e.g., back to the pre-rear loading event position). For example, the suspension controller may adjust and/or gradually adjust the compression damping back to the normal (e.g., the pre-rear loading event setting).

In some examples, the method 400 terminates at step 412. Alternatively, in some examples, the method 400 returns to step 402, from step 412, such as to provide a continuous loop of vehicle information (e.g., acceleration information and/or pitch information) to determine whether, and by how much, to adjust a damping characteristic of one or more adjustable shock absorbers. Thus, while method 400 depicts operation 408 as executing a rear loading event modifier and operation 412 as executing a normal condition modifier, it will be appreciated that, in some instances, similar aspects may be used to gradually adjust compression damping of a vehicle between such modifiers (e.g., gradually and/or as a combination thereof).

### Rear Unloading Event (Donkey Kick Event)

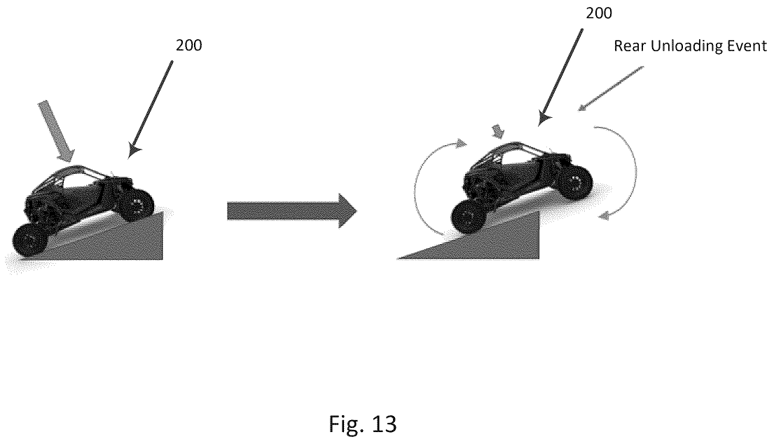

FIG. 13 illustrates an example of a rear unloading event, such as for vehicle 200 or vehicle 10. In some examples, to reduce the effects of a rear unloading event (e.g., where the rear end of a vehicle gets launched up and forward into the air, relative to the front end of the vehicle), the control system 300 may detect a change in vertical acceleration and change in pitch rate indicating that the vehicle is transitioning from an incline (e.g., of a hill or other graded terrain) into a decline. The rear unloading event is an unloading and/or forward pitch motion due to a vertical loading that has been removed from the vehicle 200. In some examples, the change in pitch rate may be an increase or a decrease (e.g., depending on the point of reference).

In some examples, after detecting the changes in vertical acceleration and pitch rate, the control system 300 may then transmit a signal to enable an adjustment of a damping characteristic of one or more adjustable shock absorbers of the vehicle. In some examples, transmitting the signal may result in or cause the adjustment of the damping characteristic. In some examples, the adjustment of a damping characteristic (e.g., change in rebound damping of one or more rear adjustable shock absorbers) may be implemented over a period of time (e.g., such that the change in rear rebound damping is not implemented all at once). In some examples, the change in rear rebound damping may be implemented all at once. In some examples, by changing (e.g., adding) rear rebound damping to the vehicle, the control system 300 may slow down or prevent the rear end of the vehicle from being launched upward and/or forward relative to the front end of the vehicle. In some examples, a rear unloading event is characterized by a transition from high vertical G-loading to low vertical G-loading, while having a forward pitch motion and pitch acceleration, such as when front tires leave the terrain or the terrain begins to fall away from the vehicle (see FIG. 13, as an example).

In some examples, the vertical acceleration is run through a low-pass filter (e.g., at 0.25 hertz). In some examples, running the vertical acceleration through a low-pass filter gives a delayed vertical acceleration signal. In some examples, the low-pass filtering is helpful, such as in cases where the vertical acceleration is dropping due to the vehicle becoming airborne. In some examples, the low-pass filter also prevents mechanisms from inadvertently triggering. In some examples, prior to performing calculations using the vertical acceleration and/or pitch acceleration, mechanisms provided herein verify that the vertical acceleration was/is greater than 1G and that the pitch acceleration is in a positive rotational direction (e.g., as illustrated by the rotational arrows pointing clockwise in FIG. 13). In some examples, thresholds may be calibrated or otherwise configured, such that, for example, the acceleration threshold is different than 1G. In some examples, the low-pass filter is providing a phase delayed vertical acceleration signal that is representative of being previously “vertically loaded,” such that when the phase delayed vertical acceleration signal is coupled with a forward pitch motion and acceleration mechanisms provided herein can determine that a kick event is occurring.

In some examples, the change in vehicle component positioning, change in vertical acceleration, and/or change in pitch rate are compared to one or more thresholds to determine whether to implement an adjustment of a damping characteristic to one or more adjustable shock absorbers of the vehicle. Therefore, by comparing the changes to such thresholds, mechanisms provided herein may ensure that adjustments to damping characteristics of adjustable shock absorbers are not made during relatively normal driving conditions, but rather only in rear unloading events.

In some examples, the vertical acceleration is multiplied by the pitch rate to determine a read unloading event score and/or magnitude. In some examples, a pitch acceleration (e.g., rate of change of a pitch rate) is determined and used in calculations discussed herein, such as instead of the pitch rate. In some examples, the rear unloading event score is compared to a threshold to determine whether to implement an adjustment of a damping characteristic to one or more adjustable shock absorbers of the vehicle. Additional and/or alternative calculations, which use and/or are based on the changes in acceleration, vehicle component positioning, and/or pitch rate, to calculate the rear unloading event score, should be recognized by those of ordinary skill in the art.

In some examples, the rear unloading event score, change in acceleration, vehicle component positioning, and/or change in pitch rate may be compared to a look-up table to determine whether to adjust a damping characteristic of one or more adjustable shock absorbers of the vehicle. In some examples, the comparison to the look-up table may be used to determine what type of damping characteristic (e.g., compression damping and/or rebound damping) to adjust. In some examples, the comparison to the look-up table may be used to determine how much to adjust the damping characteristic of the one or more adjustable shock absorbers of the vehicle.

In some examples, the thresholds to which the changes in vertical acceleration, vehicle component positioning, and/or pitch rate are compared may be calibrated. For example, the thresholds may be calibrated based on and/or correspond to a type of vehicle (e.g., vehicle model), mode of vehicle (e.g., ECO mode, sport mode, work mode, two-wheel drive, four-wheel drive, etc.), operator preference, manufacture preference, historical data of vehicle component positioning, acceleration and/or pitch information (e.g., vertical acceleration and pitch rate) collected over a duration of time (e.g., hours, days, months years), or other factors which should be recognized by those of ordinary skill in the art. Similarly, in some examples, the look-up table may be calibrated. For example, the look-up table may be calibrated based on and/or correspond to a type of vehicle (e.g., vehicle model), mode of vehicle (e.g., ECO mode, sport mode, work mode, two-wheel drive, four-wheel drive, etc.), operator preference, manufacture preference, historical data of vehicle component positioning, acceleration and/or pitch information (e.g., vertical acceleration and pitch rate) collected over a duration of time (e.g., hours, days, months years), or other factors which should be recognized by those of ordinary skill in the art.

In some examples, the control system 300 functions continuously, such that adjustments to damping characteristics of one or more shock absorbers of the vehicle are made smoothly, rather than as a binary on/off function. In some examples, the vertical acceleration and/or change in pitch rate are received from an IMU, such as the IMU 37 of FIG. 10. In some examples, the vehicle component positioning measurements are received from a shock absorber position sensor (e.g., such as when measuring the position of shock absorbers). In some examples, the vehicle component positioning measurements are received from another vehicle component positioning sensor corresponding to one or more particular vehicle components. In some examples, the control system 300 may be in communication with other types of sensors, such as wheel acceleration sensors, shock acceleration sensors, axle sensors, camera sensors, radar sensors, LIDAR sensors, or any other sensors recognized by those of ordinary skill in the art which may be used to detect when vehicle suspension is going to compress or unload. Accordingly, in some examples, the control system 300 can transmit one or more signals to enable adjustments to one or more adjustable shock absorbers, in addition to or independent of kinematic sensors of a vehicle.

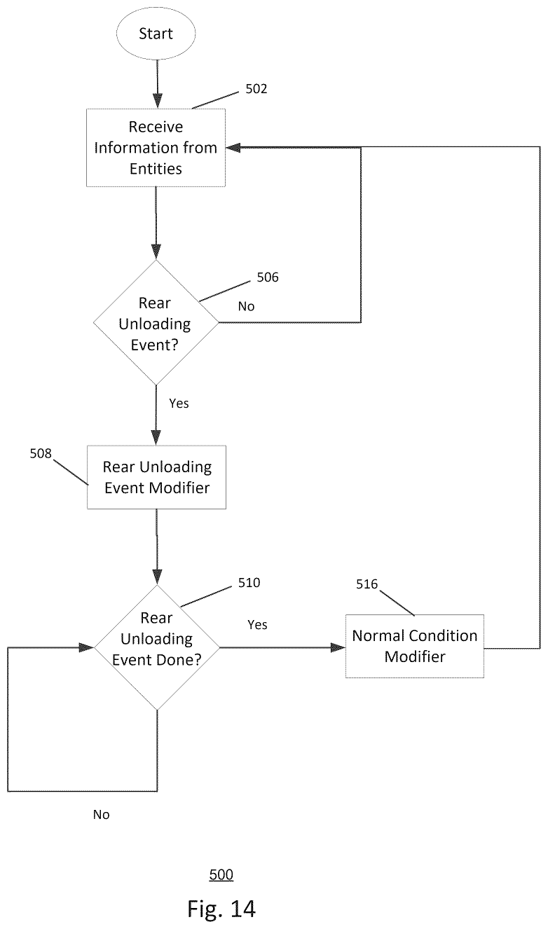

FIG. 14 shows an example flowchart describing the operation of the suspension controller 86 during a rear unloading event. The flowchart illustrates an example method or process 500. In some examples, the method 500 is a method of adjusting one or more adjustable shock absorbers. As will be described in more detail below, by adjusting the rebound damping of one or more adjustable shock absorbers 18 due to a rear unloading event, the suspension controller 86 may prevent the rear end of the vehicle 10 from launching upward and/or forward with respect to the front end of the vehicle 10.

In operation, at step 502, the suspension controller 86 may receive information (e.g., inputs) from one or more entities (e.g., sensors, devices, and/or subsystems) of vehicle 10. For example, the suspension controller 86 may receive (e.g., retrieve and/or obtain) information (e.g., data packets and/or signals indicating sensor readings) from the one or more sensors, devices, and/or subsystems. In some instances, the suspension controller 86 may receive information indicating the x, y, and/or z-axis acceleration from the chassis accelerometer 30 and/or IMU 37. For example, referring back to FIG. 3, the chassis accelerometer 30 and/or IMU 37 may measure the x, y, and/or z-axis acceleration values for the vehicle 10, and may provide the acceleration values to the suspension controller 86. Further, the suspension controller 86 may receive information indicating a pitch rate of the vehicle, such as from the IMU 37. Still further, the suspension controller 86 may receive information indicating a position of a component of the vehicle, such as from a shock absorber positioning sensor and/or a positioning sensor configured to monitor the position of another vehicle component.

At step 506, the suspension controller 86 may determine whether a rear unloading event is occurring. For example, the suspension controller 86 may determine whether a rear unloading event occurring based on the z-axis acceleration value (i.e., vertical acceleration), pitch rate of the vehicle, and or positioning of one or more vehicle components. For instance, the suspension controller 86 may compare the z-axis acceleration and pitch rate values with one or more thresholds (e.g., one or more pre-defined, pre-programmed, and/or user-defined thresholds) to determine whether the vehicle 10 is in a rear unloading event. If the z-axis acceleration value and pitch rate value are greater than the one or more thresholds, the method 500 may move to step 508. If the z-axis acceleration value and pitch rate value are less than the thresholds, the method 500 may move back to step 502 and repeat.

In some examples, the vertical acceleration is run through a low-pass filter (e.g., at 0.25 hertz). In some examples, running the vertical acceleration through a low-pass filter gives a delayed vertical acceleration signal. In some examples, the low-pass filtering is helpful, such as in cases where the vertical acceleration is dropping due to the vehicle becoming airborne. In some examples, the low-pass filter also prevents mechanisms from inadvertently triggering. In some examples, prior to performing calculations using the vertical acceleration and/or pitch acceleration, mechanisms provided herein verify that the vertical acceleration was/is greater than 1 and that the pitch acceleration is in a positive rotational direction (e.g., as illustrated by the rotational arrows pointing clockwise in FIG. 13).

In some examples, the suspension controller 86 may use any of a plurality of different techniques for comparing the z-axis acceleration and pitch rate to thresholds. In some examples, the z-axis acceleration is multiplied by the pitch rate to determine a rear unloading event score and/or magnitude. In some examples, the rear loading event score is compared to a threshold to determine whether to implement an adjustment of a damping characteristic to one or more adjustable shock absorbers of the vehicle. Additional and/or alternative calculations, which use and/or are based on the changes in acceleration and pitch rate, to calculate the rear unloading event score, should be recognized by those of ordinary skill in the art.

In some examples, the rear unloading event score, change in acceleration, and/or change in pitch rate may be compared to a look-up table to determine whether to adjust a damping characteristic of one or more adjustable shock absorbers of the vehicle. In some examples, the comparison to the look-up table may be used to determine what type of damping characteristic (e.g., compression damping and/or rebound damping) to adjust. In some examples, the comparison to the look-up table may be used to determine how much to adjust the damping characteristic of the one or more adjustable shock absorbers of the vehicle.

At step 508, the suspension controller 86 may determine a rear unloading event modifier for one or more of the adjustable shock absorbers 18. For example, the suspension controller 86 may provide information (e.g., one or more commands) to the adjustable shock absorbers 18 to increase and/or gradually increase the rebound damping. By increasing the adjustable shock absorbers 18, the vehicle 10 may prevent or reduce the extent to which the rear of the vehicle unloads and/or pitches forward with respect to the front of the vehicle.

At step 510, the suspension controller 86 may determine whether a rear unloading event has occurred and/or is done/completed. For example, similar to step 506, the suspension controller 86 may determine whether the rear unloading event is done based on the z-axis acceleration value and/or pitch rate of the vehicle. For instance, the suspension controller 86 may compare the z-axis acceleration value and/or pitch rate with one or more thresholds (e.g., one or more pre-defined, pre-programmed, and/or user-defined thresholds) to determine whether the vehicle 10 is no longer in a rear unloading event. In some examples, the suspension controller 86 may use the same thresholds as in step 506.

At step 512, the suspension controller 86 may execute a normal condition modifier. For example, the suspension controller 86 may adjust and/or gradually adjust the rebound damping back to normal (e.g., back to the pre-rear unloading event position).

In some examples, the method 500 terminates at step 512. Alternatively, in some examples, the method 500 returns to step 502, from step 512, such as to provide a continuous loop of vehicle information (e.g., acceleration information and/or pitch information) to determine whether, and by how much, to adjust a damping characteristic of one or more adjustable shock absorbers. Thus, while method 400 depicts operation 408 as executing a rear loading event modifier and operation 412 as executing a normal condition modifier, it will be appreciated that, in some instances, similar aspects may be used to gradually adjust rebound damping of a vehicle between such modifiers (e.g., gradually and/or as a combination thereof).

While the rear unloading event and rear loading event have been described in detail above, one of ordinary skill in the art should recognize that the suspension control system 300 may be used to operate the suspension controller 86 during other types of events and/or operations. For example, other types of events and/or operations with which the suspension control system 300 may be used include a breaking event, cornering event, airborne event, hill climbing event, hill sliding event, rock crawler operation, and/or other types of events/operations that may be recognized by those of ordinary skill in the art, such as discussed in U.S. Pat. No. 11,904,648, entitled ADJUSTABLE SUSPENSIONS AND VEHICLE OPERATION FOR OFF-ROAD RECREATIONAL VEHICLES (filed on Jul. 19, 2021), and U.S. Pat. No. 10,987,987, entitled VEHICLE HAVING ADJUSTABLE COMPRESSION AND REBOUND DAMPING (filed Nov. 21, 2018), which are assigned to the present assignee and the entire disclosures are expressly incorporated by reference herein.

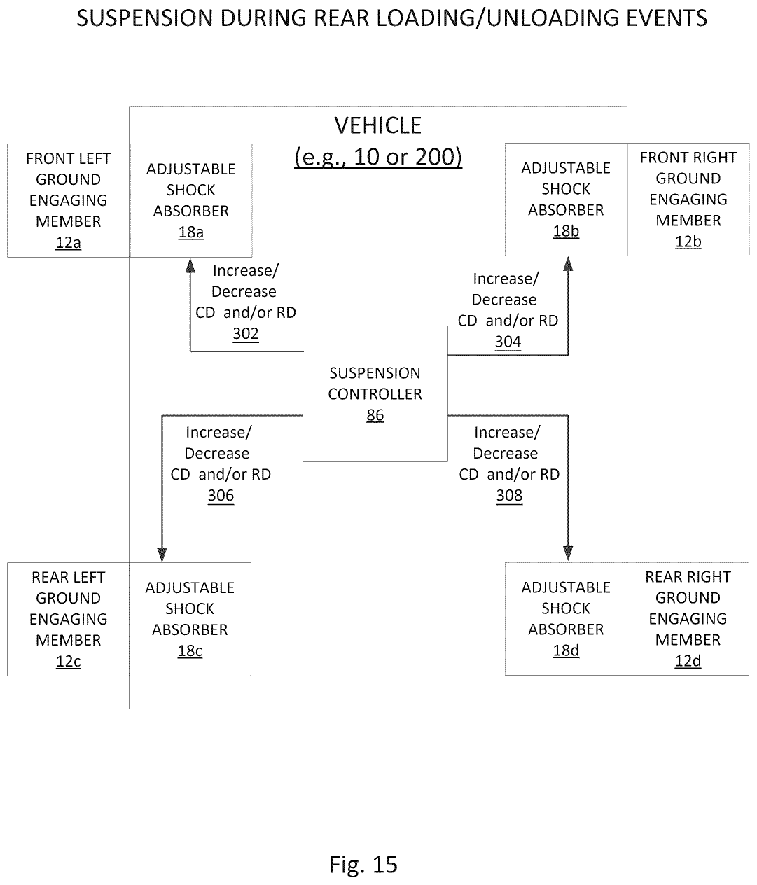

FIG. 15 shows an example of the suspension controller 86 adjusting the shock absorbers 18 for the vehicle 10 during a rear loading or rear unloading event. In some examples, for better performance during a rear loading and/or unloading event, a vehicle, such as vehicle 10, may use a controller 20 (e.g., the suspension controller 86) to adjust the rebound and/or compression damping. For instance, during a rear loading event, the suspension controller 86 may adjust (e.g., increase) the compression damping of the shock absorbers 18 (e.g., rear shock absorbers 18c, 18d), which may cause the vehicle 10 to not bottom out (e.g., at all or to a reduced degree) during a rear loading event. In some examples, during a rear unloading event, the suspension controller 86 may adjust (e.g., increase) the rebound damping of the shock absorber 18 (e.g., rear shock absorbers 18c, 18d), which may cause the rear end of the vehicle to not get launched up and/or forward into the air (e.g., at all or to a reduced degree), relative to the front end of the vehicle.

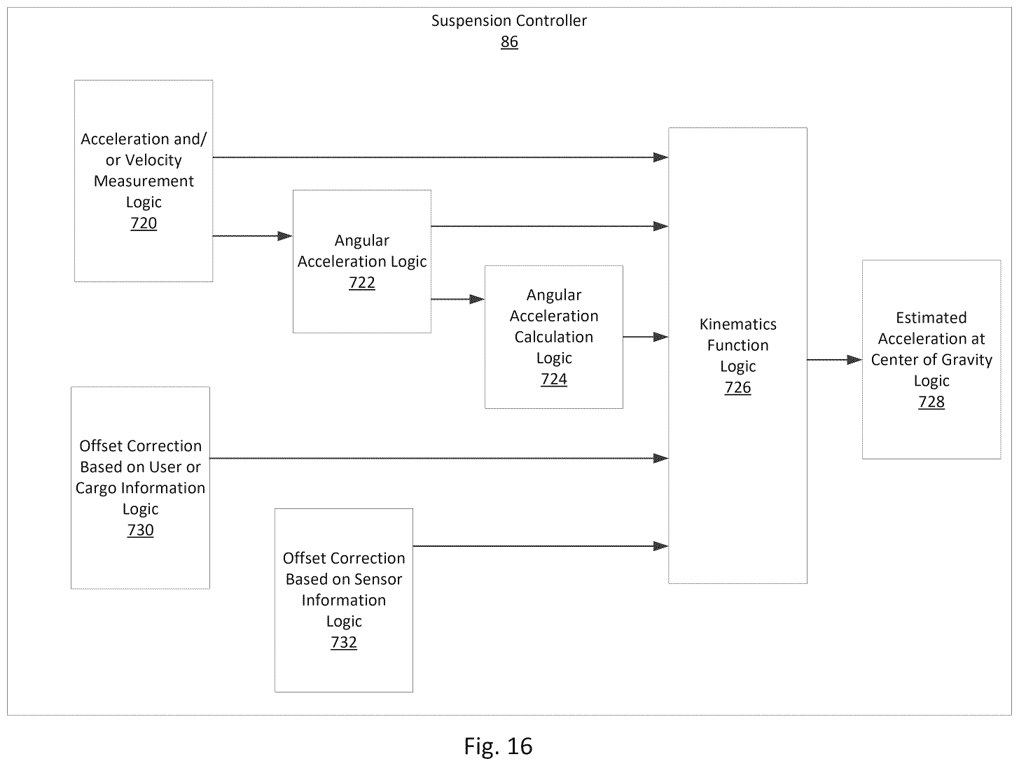

FIG. 16 shows a schematic block diagram illustrating an example of logic components in the suspension controller 86. For example, the suspension controller 86 includes one or more logic components, such as an acceleration and/or velocity measurement logic 720, angular acceleration logic 722, angular acceleration calculation logic 724, kinematics function logic 726, estimated acceleration at center of gravity (CG) logic 728, offset correction based on user or cargo information logic 730, and/or offset correction based on sensor information logic 732. The logic 720, 722, 724, 726, 728, 730, and/or 732 is any suitable logic configuration including, but not limited to, one or more state machines, processors that execute kernels, and/or other suitable structure as desired.

Further, in some examples, the suspension controller 86 and/or the controller 20 may include memory and one or more processors. The memory may store computer-executable instructions that when executed by the one or more processors cause the processors to implement one or more methods and/or procedures discussed herein. Additionally, various components (e.g., logic) depicted in FIG. 16 are, in embodiments, integrated with various ones of the other components depicted therein (and/or components not illustrated), all of which are considered to be within the ambit of the present disclosure. In some embodiments, various components depicted in FIG. 16 may be integrated with components discussed earlier herein with respect to other figures of the present disclosure.

In operation, at step 702, the suspension controller 86 (e.g., logic 720) may receive vehicle movement information from one or more entities (e.g., sensors, devices, and/or subsystems) of vehicle 10. For example, the suspension controller 86 may receive vehicle movement information indicating the acceleration and/or velocity of the vehicle 10 from one or more sensors. For instance, the logic 720 may receive x, y, and/or z acceleration values (e.g., linear acceleration values) from a sensor, such as the IMU 37 and/or the chassis accelerometer 30. The logic 720 may also receive x, y, and/or z angular velocity values from a sensor, such as the IMU 37 and/or the gyroscope 31. The logic 720 may also receive pitch values from the IMU 37 and/or another sensor.

At step 704, the suspension controller 86 (e.g., logic 730) may receive user or cargo information from one or more entities (e.g., sensors, devices, and/or subsystems) of vehicle 10. In some instances, the suspension controller 86 may receive user or cargo information from the operator interface 22. For example, the operator interface 22 may provide, to the suspension controller 86, user information indicating a number of riders in the vehicle 10 and/or a weight or mass corresponding to the riders in the vehicle 10. Additionally, and/or alternatively, the operator interface 22 may provide, to the suspension controller 86, cargo information indicating a weight or mass of cargo that the vehicle 10 is carrying.

In some examples, the suspension controller 86 may receive the user or cargo information from one or more sensors. For example, one or more sensors, such as seat belt sensors, may provide, to the suspension controller 86, information indicating the number of riders in the vehicle 10 (e.g., when a user puts on their seat belt, the seat belt sensor may provide information indicating the seat belt is engaged to the suspension controller 86).

At step 706, the suspension controller 86 (e.g., the logic 722 and/or 724) may determine the angular acceleration for the vehicle 10. For example, the logic 722 may filter the angular velocity and/or rates received from a sensor, such as the IMU 37 and/or gyroscope 31. The logic 724 may differentiate the angular rates to determine the angular acceleration.

At step 708, the suspension controller 86 (e.g., the logic 732) may determine a first offset correction based on a distance between a sensor (e.g., the IMU 37, the chassis accelerometer 30, and/or the gyroscope 31) and the CG of the vehicle 10. The CG of the vehicle 10 may be pre-programmed and/or pre-defined. Additionally, and/or alternatively, the suspension controller 86 (e.g., the logic 732) may determine the first offset correction based on a distance between a sensor (e.g., the IMU 37, the chassis accelerometer 30, and/or the gyroscope 31) and the suspension controller 86.

At step 710, the suspension controller 86 (e.g., the logic 730) may determine a second offset correction based on the user and/or cargo information received at step 704. For example, based on the number of users, weight/mass of users, and/or weight/mass of the cargo, the logic 730 may determine a second offset correction.

At step 712, the suspension controller 86 (e.g., the logic 726 and/or 728) may determine an estimated acceleration at the CG of the vehicle 10. For example, the logic 726 may receive information from the logic 720 (e.g., the linear acceleration values), the logic 724 (e.g., the determined angular acceleration values), the logic 730 (e.g., the second offset based on the user or cargo information), and/or the logic 732 (e.g., the first offset based on the sensor information). The logic 726 may use a kinematics function to determine the 3-axis estimated acceleration at the CG of the vehicle 10. The logic 726 may provide the 3-axis estimated acceleration at the CG of the vehicle 10 to the logic 728. Then, the method 700 may return to step 702, and may repeat continuously.

In some examples, the logic 726 may receive and/or store the 3-axis (e.g., x, y, and/or z-axis) estimated acceleration values at the CG of the vehicle 10. Additionally, and/or alternatively, the methods disclosed throughout this disclosure may use the determined estimated acceleration values at the CG of the vehicle 10 to execute rear unloading event modifiers, rear loading event modifiers, and/or other event or operation modifiers which may be recognized by those of ordinary skill in the art. For example, the suspension controller 86 may use the estimated acceleration values at the CG of the vehicle 10 to determine and/or detect events (e.g., rear loading events, rear unloading events, etc.). Additionally, and/or alternatively, the suspension controller 86 may use the estimated acceleration values at the CG of the vehicle 10 to adjust the compression damping and/or rebound damping of the adjustable shock absorbers 18.

### Stabilizer Bar

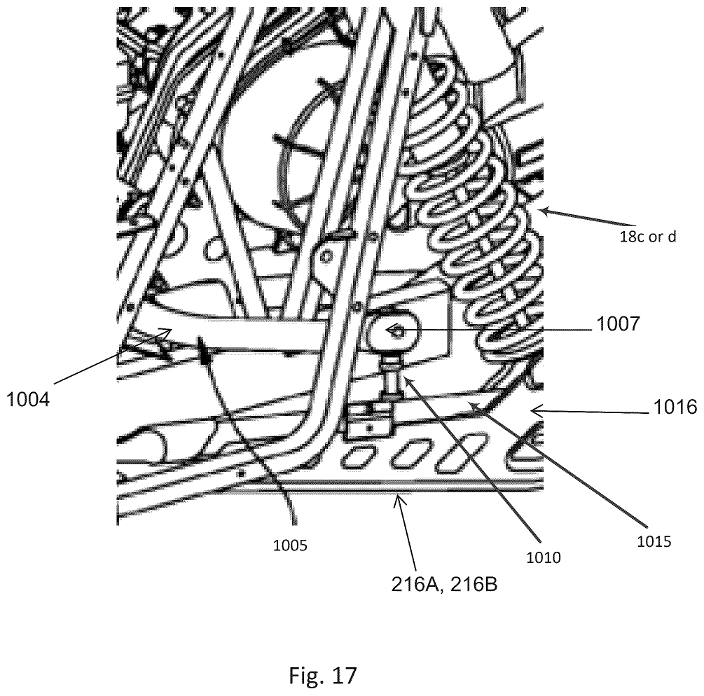

FIG. 17 illustrates a representative view of a stabilizer bar assembly 1004 of a vehicle, such as vehicle 10. In embodiments, vehicle 10 may include stabilizer bar 1004 coupled between the rear suspension (e.g., rear suspension 216A, 216B) and frame 14. In embodiments, stabilizer bar assembly 1004 includes a stabilizer bar 1005 and one or more links 1010. In embodiments, stabilizer bar assembly 1004 is an adjustable stabilizer bar. In embodiments, the one or more links 1010 are adjustable links with adjustable suspension characteristics (e.g., locking status, damping characteristic). In embodiments, the one or more links 1010 are adjustable shock absorbers with adjustable suspension characteristics (e.g., locking status, damping characteristic). In embodiments, the links 1010 are operably coupled to a controller (e.g., suspension controller 86).

In embodiments, a first link 1010 may be coupled between a first end 1007 of the stabilizer bar 1005 and a first trailing arm or control arm 1016 of rear suspension 216A and a second link (not shown, similar to or the same as first link 1010) may be coupled between a second end (not shown, similar to first end 1007) of stabilizer bar 1005 and a second trailing arm or control arm (not shown, similar to control arm 1016) of rear suspension 216B. In embodiments, a control arm or steering arm 1015 extends between frame 14 and a ground engaging member.

In embodiments, the one or more links 1010 are adjustable links including a first adjustable link 1010 coupled between the first end 1007 of the stabilizer bar 1005 and the first trailing arm or control arm 1016 of rear suspension 216A and the second adjustable link (not shown, similar to or the same as first link 1010) may be coupled between the second end (not shown, similar to first end 1007) of stabilizer bar 1005 and the second trailing arm or control arm (not shown, similar to control arm 1016) of rear suspension 216B

The stabilizer bar assembly 1004 may be in the rear of the vehicle, and located close to a rear adjustable shock absorber, such as shock absorber 18c. In embodiments, stabilizer bar assembly 1004 may be positioned in a front of the vehicle and coupled between front suspensions 214A, 214B.

In embodiments, adjustable links 1010 may be capable of locking (e.g., maintaining a static position) or unlocking (e.g., allowing movement to increase or decrease the length of adjustable link 1010). In embodiments, adjustable links 1010 may be capable of operating at discrete damping levels (e.g., compression and/or rebound damping). In embodiments, adjustable links 1010 may be capable of operating at an infinite (e.g., continuous) number of damping levels (e.g., compression and/or rebound damping). In embodiments, a controller (e.g., suspension controller 86) may send and/or receive signals related to damping characteristics, locking characteristics, or other characteristics to adjustable links 1010. For example, the controller can actively control the adjustable links 1010, such as in addition to controlling the shock absorbers 18.

Also, similar to the adjustable shock absorbers 18, the suspension controller 86 may provide one or more commands to adjust the damping characteristics of the stabilizer bar adjustable shock absorbers 1010. In embodiments, suspension controller 86 may provide one or more commands to adjust a locking status (e.g., locked or unlocked) of the one or more adjustable links 1010. In embodiments, in response to detecting a rear loading event and/or a rear unloading event, suspension controller 86 may provide one or more commands to adjust a damping characteristic to the stabilizer bar assembly 1004. In embodiments, in response to a rear loading event and/or a rear unloading event, suspension controller 86 may provide one or more commands to adjust a locking status of the stabilizer bar assembly 1004. In some embodiments, the stabilizer bar assembly 1004 has two states (e.g., open or locked). For example, the adjustable links 1010 can be open or locked. In some embodiments, an increase in damping for the stabilizer bar assembly 1004 while in an open state has variable damping (e.g., variable damping of the adjustable links 1010).

In embodiments, suspension controller 86 may simultaneously provide one or more commands to adjustable links 1010 and one or more commands to adjustable shock absorbers 18a, 18b, 18c, 18d. In embodiments, in response to a rear loading event and/or a rear unloading event, suspension controller 86 may provide one or more commands to adjust a suspension characteristic of the stabilizer bar assembly 1004 and a suspension characteristic of one or more of adjustable shock absorbers 18a, 18b, 18c, 18d. In embodiments, in response to a rear loading event and/or a rear unloading event, suspension controller 86 may provide a command to increase or decrease the stiffness of stabilizer bar assembly 1004. In embodiments, the stiffness of stabilizer bar assembly 1004 may be increased by locking one or more of links 1010 or by increasing a compression damping of one or more of links 1010. In embodiments, the stiffness of stabilizer bar assembly 1004 may be decreased by unlocking one or more of links 1010 or by decreasing a compression damping of one or more of links 1010.

Exemplary stabilizer bars are described in U.S. Pat. No. 9,365,251 (filed Jun. 14, 2016, entitled SIDE-BY-SIDE VEHICLE), and U.S. Provisional Patent Application No. 63/528,547 (filed Jul. 24, 2023, entitled ADJUSTABLE SUSPENSION ASSEMBLIES AND METHODS OF USE THEREOF) which are assigned to the present assignee and the entire disclosures of which are expressly incorporated by reference herein.

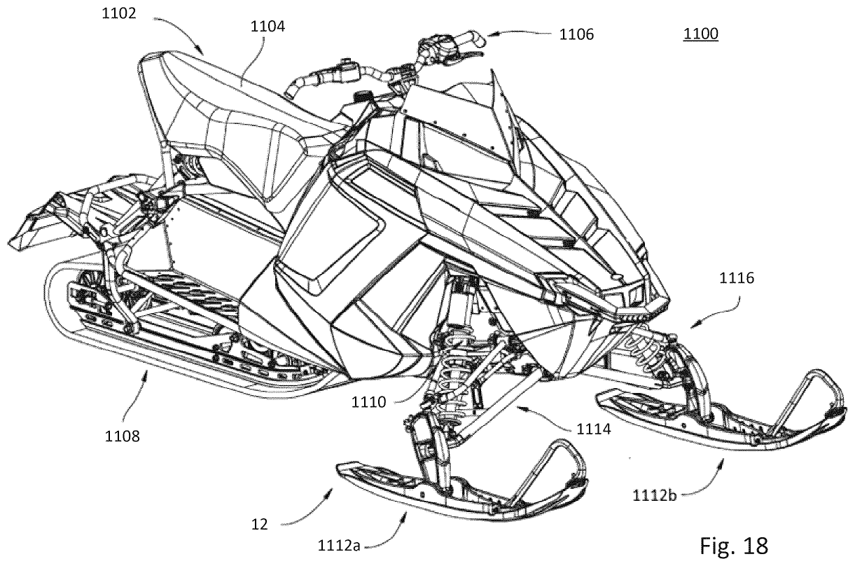

FIG. 18 illustrates a view of an exemplary vehicle 1100, such as a snowmobile. Vehicle 1100, as illustrated, includes a plurality of ground engaging members 12. Illustratively, the ground engaging members 12 are the endless track assembly 1108 and a pair of front skis 1112a and 1112b. The endless track assembly 1108 is operatively coupled to power system 60 (see FIG. 4) to power the movement of vehicle 1100. The vehicle may also include a seat 1102 and a seat surface 1104. Also, the vehicle may include handlebars 1106.

Further, the suspensions 1114 and 1116 are coupled to the frame of the vehicle 1100 and the pair of front skis 1112a and 1112b. The suspensions 1114 and 1116 may include adjustable shock absorbers, such as the adjustable shock absorber 1110. Also, the endless track assembly 1108 may also be coupled to one or more suspensions and/or adjustable shock absorbers.

The vehicle 1100 may be the same and/or include components of vehicle 10. For example, the vehicle 1100 may include the plurality of vehicle condition sensors 40 described above, and may also include one or more controllers, such as the suspension controller 86. The suspension controller 86 may receive information from the plurality of vehicle condition sensors 40. Using the received information, the suspension controller 86 may adjust the compression and/or rebound damping of the adjustable shock absorbers, such as adjustable shock absorber 1110 as described above. Additional details regarding vehicle 1100 are provided in U.S. Pat. Nos. 9,809,195 and 8,994,494, assigned to the present assignee, the entire disclosures of which are expressly incorporated by reference herein. Further, additional details regarding damping control for shock absorbers of the vehicle 1100 are provided in US Patent Pub. No. 2021/0362806, entitled SYSTEMS AND METHODS OF ADJUSTABLE SUSPENSIONS FOR OFF-ROAD RECREATIONAL VEHICLES (filed May 19, 2021), assigned to the present assignee, the entire disclosures of which is expressly incorporated by reference herein

In embodiments, substantially zero is any value which is effectively zero. For example, a substantially zero value does not provide an appreciable difference in the operation compared to when the value is zero. Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The following clauses illustrate example subject matter described herein.

Clause 1: A recreational vehicle, comprising: a plurality of ground engaging members; a frame supported by the plurality of ground engaging members; a plurality of suspensions, wherein each of the plurality of suspensions couples a ground engaging member, from the plurality of ground engaging members, to the frame, wherein the plurality of suspensions includes a plurality of adjustable shock absorbers; at least one sensor positioned on the recreational vehicle and configured to provide one or more of acceleration information, pitch information, or position information to a controller; and the controller operatively coupled to the at least one sensor and the plurality of adjustable shock absorbers, wherein the controller is configured to: receive, from the at least one sensor, the one or more of acceleration information, pitch information, or position information; determine, based on the one or more of acceleration information, pitch information, or position information, to adjust damping of at least one of the plurality of adjustable shock absorbers; and provide, to the at least one of the plurality of adjustable shock absorbers, one or more commands to result in an adjustment of a damping characteristic of the at least one of the plurality of adjustable shock absorbers.

Clause 2: The recreational vehicle of claim 1, further comprising a stabilizer bar coupled between a rear suspension of the plurality of suspensions and the frame.

Clause 3: The recreational vehicle of any of the preceding clauses, wherein the recreational vehicle is a snowmobile, and wherein the plurality of ground engaging members include skis.

Clause 4: The recreational vehicle of any of the preceding clauses, wherein the controller is further configured to: determine, based on the one or more of acceleration information, pitch information, and position information, that a rear loading event is occurring, wherein the one or more commands comprise a command to increase a compression damping characteristic of the at least one of the plurality of adjustable shock absorbers.

Clause 5: The recreational vehicle of clause 4, wherein, to determine that the rear loading event is occurring, a rear loading event score is calculated based on the one or more of acceleration information, pitch information, and position information, and the increase in the compression damping characteristic is based on the magnitude of the rear loading event score.

Clause 6: The recreational vehicle of any one of clauses 1-3, wherein the controller is further configured to: determine, based on the one or more of acceleration information, pitch information, and position information that a rear unloading event is occurring, wherein the one or more commands comprise a command to increase a rebound damping characteristic of the at least one of the plurality of adjustable shock absorbers.

Clause 7: The recreational vehicle of clause 6, wherein, to determine that the rear unloading event is occurring, a rear unloading event score is calculated based on the one or more of acceleration information, pitch information, and positions information, and the increase in the rebound damping characteristic is based on the magnitude of the rear unloading event score.

Clause 8: A method of adjusting one or more adjustable shock absorbers of a vehicle, the method comprising: receiving, from at least one sensor of the vehicle, acceleration information and pitch information; determining, based on the acceleration information and pitch information, to adjust damping of at least one of the one or more adjustable shock absorbers; and providing, to the at least one of the one or more adjustable shock absorbers, one or more commands to cause an adjustment of a damping characteristic of the at least one of the one or more adjustable shock absorbers.

Clause 9: The method of clause 8, wherein the at least one sensor comprises at least one of: an accelerometer or an inertial measurement unit (IMU).

Clause 10: The method of clause 8 or 9, wherein the damping characteristic comprises at least one of: a compression damping or a rebound damping.

Clause 11: The method of any one of clauses 8-10, further comprising: determining, based on the acceleration information and pitch information, that a rear loading event is occurring, by: calculating a rear loading event score based on the acceleration information and pitch information; and comparing the rear loading event score to one or more thresholds, wherein the one or more commands comprise a command to increase a compression damping characteristic of the at least one of the one or more adjustable shock absorbers.

Clause 12: The method of clause 11, wherein the one or more thresholds correspond to one or more of: a vehicle type, a vehicle mode, or historical acceleration and pitch information data.

Clause 13: The method of any one of clauses 8-10, further comprising: determining, based on the acceleration information and pitch information, that a rear unloading event is occurring, wherein the one or more commands comprise a command to increase a rebound damping characteristic of the at least one of the one or more adjustable shock absorbers.

Clause 14: The method of clause 13, wherein, to determine that the rear unloading event is occurring, a rear unloading event score is calculated based on the acceleration information and pitch information, and the increase in the rebound damping characteristic is based on the rear unloading event score.

Clause 15: A recreational vehicle, comprising: a plurality of ground engaging members; a frame supported by the plurality of ground engaging members; a plurality of suspensions, wherein each of the plurality of suspensions couples a ground engaging member, from the plurality of ground engaging members, to the frame and includes an adjustable shock absorber of a plurality of adjustable shock absorbers; at least one sensor positioned on the recreational vehicle, the at least one sensor configured to provide acceleration information and pitch information to a controller; and the controller operatively coupled to the at least one sensor and the plurality of adjustable shock absorbers, wherein the controller is configured to: receive, from the at least one sensor, the acceleration information and the pitch information; calculate an event score based on the acceleration information and the pitch information; compare the calculated event score to a threshold; and control at least one adjustable shock absorber of the plurality of adjustable shock absorbers to adjust a damping characteristic of the at least one adjustable shock absorber based on the comparison.

Clause 16: The recreational vehicle of clause 15, wherein the at least one sensor comprises at least one of: an accelerometer or an inertial measurement unit (IMU).

Clause 17: The recreational vehicle of clause 15 or 16, wherein the damping characteristic comprises at least one of: a compression damping or a rebound damping.

Clause 18: The recreational vehicle of any one of clauses 15-17, wherein controlling the at least one adjustable shock absorber comprises generating a command to increase the damping characteristic of the at least one of the plurality of adjustable shock absorbers.

Clause 19: The recreational vehicle of any one of clauses 15-18, wherein the acceleration information comprises a vertical acceleration of the recreational vehicle and wherein the score is calculated based on the vertical acceleration and the pitch information.

Clause 20: The recreational vehicle of any one of clauses 15-19, wherein the threshold corresponds to one or more of: a vehicle type, a vehicle mode, or historical acceleration and pitch information data.

The above detailed description of the present disclosure and the examples described therein have been presented for the purposes of illustration and description only and not by limitation. It is therefore contemplated that the present disclosure covers any and all modifications, variations or equivalents that fall within the scope of the basic underlying principles disclosed above and claimed herein.

What is claimed is:

1. A recreational vehicle, comprising:
a plurality of ground engaging members;
a frame supported by the plurality of ground engaging members;
a plurality of suspensions, wherein each of the plurality of suspensions couples a ground engaging member, from the plurality of ground engaging members, to the frame, wherein the plurality of suspensions includes a plurality of adjustable shock absorbers;
at least one sensor positioned on the recreational vehicle and configured to provide one or more of acceleration information, pitch information, or position information to a controller; and
the controller operatively coupled to the at least one sensor and the plurality of adjustable shock absorbers, wherein the controller is configured to:
receive, from the at least one sensor, the one or more of acceleration information, pitch information, or position information;
determine, based on the one or more of acceleration information, pitch information, or position information, to adjust damping of at least one of the plurality of adjustable shock absorbers; and
provide, to the at least one of the plurality of adjustable shock absorbers, one or more commands to result in an adjustment of a damping characteristic of the at least one of the plurality of adjustable shock absorbers.

2. The recreational vehicle of claim 1, further comprising a stabilizer bar coupled between a rear suspension of the plurality of suspensions and the frame.

3. The recreational vehicle of claim 1, wherein the recreational vehicle is a snowmobile, and wherein the plurality of ground engaging members include skis.

4. The recreational vehicle of claim 1, wherein the controller is further configured to:
determine, based on the one or more of acceleration information, pitch information, and position information, that a rear loading event is occurring,
wherein the one or more commands comprise a command to increase a compression damping characteristic of the at least one of the plurality of adjustable shock absorbers.

5. The recreational vehicle of claim 4, wherein, to determine that the rear loading event is occurring, a rear loading event score is calculated based on the one or more of acceleration information, pitch information, and position information, and the increase in the compression damping characteristic is based on the magnitude of the rear loading event score.

6. The recreational vehicle of claim 1, wherein the controller is further configured to:
determine, based on the one or more of acceleration information, pitch information, and position information that a rear unloading event is occurring,
wherein the one or more commands comprise a command to increase a rebound damping characteristic of the at least one of the plurality of adjustable shock absorbers.

7. The recreational vehicle of claim 6, wherein, to determine that the rear unloading event is occurring, a rear unloading event score is calculated based on the one or more of acceleration information, pitch information, and positions information, and the increase in the rebound damping characteristic is based on the magnitude of the rear unloading event score.

8. A method of adjusting one or more adjustable shock absorbers of a vehicle, the method comprising:
receiving, from at least one sensor of the vehicle, acceleration information and pitch information;
determining, based on the acceleration information and pitch information, to adjust damping of at least one of the one or more adjustable shock absorbers; and
providing, to the at least one of the one or more adjustable shock absorbers, one or more commands to cause an adjustment of a damping characteristic of the at least one of the one or more adjustable shock absorbers.

9. The method of claim 8, wherein the at least one sensor comprises at least one of: an accelerometer or an inertial measurement unit (IMU).

10. The method of claim 8, wherein the damping characteristic comprises at least one of: a compression damping or a rebound damping.

11. The method of claim 8, further comprising:
determining, based on the acceleration information and pitch information, that a rear loading event is occurring, by:
calculating a rear loading event score based on the acceleration information and pitch information; and
comparing the rear loading event score to one or more thresholds,
wherein the one or more commands comprise a command to increase a compression damping characteristic of the at least one of the one or more adjustable shock absorbers.

12. The method of claim 11, wherein the one or more thresholds correspond to one or more of:
a vehicle type, a vehicle mode, or historical acceleration and pitch information data.

13. The method of claim 8, further comprising:
determining, based on the acceleration information and pitch information, that a rear unloading event is occurring,
wherein the one or more commands comprise a command to increase a rebound damping characteristic of the at least one of the one or more adjustable shock absorbers.

14. The method of claim 13, wherein, to determine that the rear unloading event is occurring, a rear unloading event score is calculated based on the acceleration information and pitch information, and the increase in the rebound damping characteristic is based on the rear unloading event score.

15. A recreational vehicle, comprising:
a plurality of ground engaging members;
a frame supported by the plurality of ground engaging members;
a plurality of suspensions, wherein each of the plurality of suspensions couples a ground engaging member, from the plurality of ground engaging members, to the frame and includes an adjustable shock absorber of a plurality of adjustable shock absorbers;
at least one sensor positioned on the recreational vehicle, the at least one sensor configured to provide acceleration information and pitch information to a controller; and
the controller operatively coupled to the at least one sensor and the plurality of adjustable shock absorbers, wherein the controller is configured to:
receive, from the at least one sensor, the acceleration information and the pitch information;
calculate an event score based on the acceleration information and the pitch information;
compare the calculated event score to a threshold; and
control at least one adjustable shock absorber of the plurality of adjustable shock absorbers to adjust a damping characteristic of the at least one adjustable shock absorber based on the comparison.

16. The recreational vehicle of claim 15, wherein the at least one sensor comprises at least one of: an accelerometer or an inertial measurement unit (IMU).

17. The recreational vehicle of claim 15, wherein the damping characteristic comprises at least one of: a compression damping or a rebound damping.

18. The recreational vehicle of claim 17, wherein controlling the at least one adjustable shock absorber comprises generating a command to increase the damping characteristic of the at least one of the plurality of adjustable shock absorbers.

19. The recreational vehicle of claim 15, wherein the acceleration information comprises a vertical acceleration of the recreational vehicle and wherein the score is calculated based on the vertical acceleration and the pitch information.

20. The recreational vehicle of claim 15, wherein the threshold corresponds to one or more of: a vehicle type, a vehicle mode, or historical acceleration and pitch information data.
